(19) United States
(12) Patent Application Publication
(10) Pub. No.: US 2011/0282967 A1
(43) Pub. Date: Nov. 17, 2011

(54) SYSTEM AND METHOD FOR PROVIDING MULTIMEDIA SERVICE IN A COMMUNICATION SYSTEM

(75) Inventors: Eun-Seo LEE, Daejeon (KR); Bum-Suk Choi, Daejeon (KR)

(73) Assignee: Electronics and Telecommunications Research Institute, Daejeon (KR)

(21) Appl. No.: 13/080,095

(22) Filed: Apr. 5, 2011

(30) Foreign Application Priority Data
Apr. 5, 2010 (KR) 10-2010-0031129
Apr. 1, 2011 (KR) 10-2011-0030397

(51) Int. Cl. G06F 15/16

(52) U.S. Cl. 709/217

(57) ABSTRACT

Disclosed herein are a system and a method for providing multimedia services capable of rapidly providing various types of large-capacity multimedia contents and various sensory effects of the multimedia contents to users in real time, which generate multimedia contents of the multimedia services and generate sensory effect information representing the sensory effects of the multimedia contents, depending on service request of the multimedia services that users want to receive, encode the sensory effect information into the binary representation using a binary representation encoding scheme, converts the sensory effect information encoded by the binary representation into command information of the binary representation, and provide the multimedia contents and the sensory effects in real time through device command depending on the command information of the binary representation.

### CROSS-REFERENCES TO RELATED APPLICATIONS

The present application claims priority of Korean Patent Application Nos. 10-2010-0031129 and 10-2011-0030397, filed on Apr. 5, 2010, and Apr. 1, 2011, respectively, which are incorporated herein by reference in their entirety.

### BACKGROUND OF THE INVENTION

1. Field of the Invention

Exemplary embodiments of the present invention relate to a communication system, and more particularly, to a system and a method for providing multimedia services capable of rapidly providing various types of large-capacity multimedia contents and various sensory effects of the multimedia contents to users in real time.

2. Description of Related Art

Research into a technology providing various services having quality of services (QoS) to users at a high transmission rate has been actively progressed in a communication system. Methods for providing services requested by each user by rapidly and stably transmitting various types of service data to the users through limited resources depending on service requests of users who want to receive various types of services has been proposed in the communication system.

Meanwhile, a method for transmitting large-capacity service data at high speed depending on various service requests of users has been proposed in the current communication system. In particular, research into a method for transmitting large-capacity multimedia data at high speed depending on the service requests of the users who want to receive various multimedia services. In other words, the users want to receive higher quality of various multimedia services through the communication systems. In particular, the users may receive the higher quality of multimedia services by receiving receive the multimedia contents depending on the multimedia services and various sensory effects of the multimedia contents to higher quality of multimedia services.

However, the current communication system has a limitation in providing multimedia services requested by the users by transmitting the multimedia contents depending on the multimedia service requests of the users. In particular, as described above, a method for providing the multimedia contents and the various sensory effects of the multimedia contents to the users depending on the higher quality of various multimedia service requests of the users has not yet been proposed in the current communication system. That is, a method for providing the higher quality of various multimedia services to each user in real time by rapidly transmitting the multimedia contents and the various sensory effects has not yet been proposed in the current communication system.

Therefore, a need exists for a method for providing the higher quality of various large-capacity multimedia services depending on the service requests of users in the communication system, in particular, a method for providing the higher quality of large-capacity multimedia services requested by each user in real time.

### SUMMARY OF THE INVENTION

An embodiment of the present invention is directed to provide a system and a method for providing multimedia services in a communication system.

Further, another embodiment of the present invention is directed to provide a system and a method for providing multimedia services capable of providing high quality of various multimedia services to users at high speed and in real time depending on service requests of users in a communication system.

In addition, another embodiment of the present invention is directed to provide a system and a method for providing a multimedia service capable of providing high quality of various multimedia services to each user in real time by rapidly transmitting multimedia contents of multimedia services and various sensory effects of the multimedia contents that are received by each user in a communication system.

In accordance with an embodiment of the present invention, a system for providing multimedia services in a communication system includes: a service provider configured to provide multimedia contents of the multimedia services and sensory effect information representing sensory effects of the multimedia contents, depending on service requests of multimedia services that users want to receive; a user server configured to receive multimedia data including the multimedia contents and the sensory effect information and converts and provides the sensory effect information into command information in the multimedia data; and user devices configured to provide the multimedia contents and the sensory effects to the users in real time through device command depending on command information.

In accordance with another embodiment of the present invention, a system for providing multimedia services in a communication system, including: a generator configured to generate multimedia contents of the multimedia services and generate sensory effect information representing sensory effects of the multimedia contents, depending on service requests of multimedia services that users want to receive; an encoder configured to encode the sensory effect information using binary representation; and a transmitter configured to transmit the multimedia contents and the sensory effect information encoded by the binary representation.

In accordance with another embodiment of the present invention, a method for providing multimedia services in a communication system includes: generating multimedia contents of the multimedia services and generating sensory effect information representing sensory effects of the multimedia contents, depending on service requests of multimedia services that users want to receive; encoding the sensory effect information into binary representation using a binary representation encoding scheme; converting the sensory effect information encoded by the binary representation into command information of the binary representation; and providing the multimedia contents and the sensory effects to the users in real time through device command depending on command information of the binary representation.

### BRIEF DESCRIPTION OF THE DRAWINGS

FIG. 1 is a diagram schematically illustrating a structure of a system for providing multimedia services in accordance with an exemplary embodiment of the present invention.

FIG. 2 is a diagram schematically illustrating a structure of a service provider in the system for providing multimedia services in accordance with the exemplary embodiment of the present invention.

FIG. 3 is a diagram schematically illustrating a structure of a user server in the system for providing multimedia services in accordance with the exemplary embodiment of the present invention.

FIG. 4 is a diagram schematically illustrating a structure of a user device in the system for providing multimedia services in accordance with the exemplary embodiment of the present invention.

FIG. 5 is a diagram illustrating a location model of a sensory effect metadata in the system for providing multimedia services in accordance with the exemplary embodiment of the present invention.

FIG. 6 is a diagram illustrating movement patterns in the sensory effects of the system for providing multimedia services in accordance with the exemplary embodiment of the present invention.

FIG. 7 is a diagram illustrating motion orbit sample patterns in the sensory effects of the system for providing multimedia services in accordance with an exemplary embodiment of the present invention.

FIG. 8 is a diagram illustrating incline patterns in the sensory effects of the system for providing multimedia services in accordance with an exemplary embodiment of the present invention.

FIG. 9 is a diagram illustrating shake patterns in the sensory effects of the system for providing multimedia services in accordance with the exemplary embodiment of the present invention.

FIG. 10 is a diagram illustrating wave patterns in the sensory effects of the system for providing multimedia services in accordance with the exemplary embodiment of the present invention.

FIG. 11 is a diagram illustrating spin patterns in the sensory effects of the system for providing multimedia services in accordance with the exemplary embodiment of the present invention.

FIG. 12 is a diagram illustrating turn patterns in the sensory effects of the system for providing multimedia services in accordance with the exemplary embodiment of the present invention.

FIG. 13 is a diagram illustrating collide patterns in the sensory effects of the system for providing multimedia services in accordance with the exemplary embodiment of the present invention.

FIG. 14 is a diagram illustrating horizontal direction movement patterns in the sensory effects of the system for providing multimedia services in accordance with the exemplary embodiment of the present invention.

FIG. 15 is a diagram illustrating vertical direction movement patterns in the sensory effects of the system for providing multimedia services in accordance with the exemplary embodiment of the present invention.

FIG. 16 is a diagram illustrating directional incline patterns in the sensory effects of the system for providing multimedia services in accordance with an exemplary embodiment of the present invention.

FIG. 17 is a diagram illustrating directional shake patterns in the sensory effects of the system for providing multimedia services in accordance with an exemplary embodiment of the present invention.

FIG. 18 is a diagram illustrating a shake motion distance in the sensory effects of the system for providing multimedia services in accordance with an exemplary embodiment of the present invention.

FIGS. 19 and 20 are diagrams illustrating a wave motion direction in the sensory effects of the system for providing multimedia services in accordance with an exemplary embodiment of the present invention.

FIGS. 21 and 22 are diagrams illustrating a wave motion start direction in the sensory effects of the system for providing multimedia services in accordance with an exemplary embodiment of the present invention.

FIG. 23 is a diagram illustrating a wave motion distance in the sensory effects of the system for providing multimedia services in accordance with an exemplary embodiment of the present invention.

FIG. 24 is a diagram illustrating a turn pattern direction in the sensory effects of the system for providing multimedia services in accordance with the exemplary embodiment of the present invention.

FIG. 25 is a diagram illustrating horizontal direction collide patterns in the sensory effects of the system for providing multimedia services in accordance with the exemplary embodiment of the present invention.

FIG. 26 is a diagram illustrating vertical direction collide patterns in the sensory effects of the system for providing multimedia services in accordance with the exemplary embodiment of the present invention.

FIG. 27 is a diagram schematically illustrating a process of providing multimedia services of the system for providing multimedia services in accordance with the exemplary embodiment of the present invention.

### DESCRIPTION OF SPECIFIC EMBODIMENTS

Exemplary embodiments of the present invention will be described below in more detail with reference to the accompanying drawings. Only portions needed to understand an operation in accordance with exemplary embodiments of the present invention will be described in the following description. It is to be noted that descriptions of other portions will be omitted so as not to make the subject matters of the present invention obscure.

Exemplary embodiments of the present invention proposes a system and a method for providing multimedia services capable of providing high quality of various multimedia services at high speed and in real time in a communication system. In the exemplary embodiments of the present invention provide high quality of various multimedia services requested by each user in real time by transmitting multimedia contents of multimedia services and various sensory effects of the multimedia contents provided to each user at high speed, depending on service requests of users that want to receive high quality of various services.

Further, the exemplary embodiments of the present invention transmit the multimedia contents of the multimedia services and the various sensory effects of the above-mentioned multimedia contents at high speed by maximally using available resources so as to provide multimedia services to users. In this case, the multimedia contents of the multimedia services that the users want to receive are large-capacity data. Most of the available resources are used to transmit the multimedia contents. Therefore, the available resources are more limited so as to transmit the various sensory effects of the multimedia contents that are essentially transmitted and provided so as to provide high quality of various multimedia services requested by users. As a result, there is a need to transmit the large-capacity multimedia contents and the various sensory effects at high speed so as to provide high quality of various multimedia services to users at high speed and in real time.

That is, the exemplary embodiments of the present invention, in order to provide the multimedia services requested by each user at high speed and in real time through available resources so as to provide the high quality of various multimedia services, the data size of the sensory effect information is minimized by encoding the multimedia contents are encoded, in particular, encoding information (hereinafter, referred to as “sensory effects information”) indicating the various sensory effects of the multimedia contents using binary representation, such that the multimedia contents and the various sensory effects of the multimedia contents are rapidly transmitted and the multimedia contents and the sensory effects are provided to each user in real time, that is, the high quality of various multimedia services are provided to the user in real time.

Further, the exemplary embodiments of the present invention provide the multimedia contents services and the various sensory effects of the multimedia contents to each user receiving the multimedia in real time by transmitting information on the various sensory effects of the multimedia using the binary representation encoding scheme at high speed in a moving picture experts group (MPEG)-V, that is, transmitting sensory effect data or sensory effect metadata using the binary representation at high speed.

In this case, the exemplary embodiments of the present invention relate to the sensory effect information, that is, the high speed transmission of the sensory effect data or the sensory effect metadata in Part 3 of MPEG-V. The exemplary embodiments of the present invention allows the user provider generating, providing, or selling the high quality of various multimedia services depending on the service requests of each user to encode the multimedia contents of the multimedia services contents and transmit the encoded multimedia contents at high speed, in particular, encode the various sensory effects of the multimedia contents using the binary representation, that is, the sensory effect information using the binary representation encoding scheme. Further, the service provider transmits the multimedia contents and the sensory effect information encoded by the binary representation to the user server, for example, the home server at high speed.

In this case, since the service provider may encode and transmit the sensory effect information using the binary representation, as described above, the sensory effect information is transmitted at high speed by maximally using the very limited available resources to transmit the sensory effect information, that is, the remaining available resources other than the resources used to transmit the large-capacity multimedia contents. Therefore, the service provider transmits the multimedia contents and the sensory effect information to the user server at high speed, such that it provides the multimedia contents and the various sensory effects of the multimedia contents to each user in real time.

In this case, the user server outputs the multimedia services and transmits the multimedia contents and the sensory effect information to the user devices that provide the actual multimedia services to each user. In this case, the user server encodes the sensory effect information using the binary representation, converts the encoded sensory effect information into command information for device command of each user device, and transmits the command information converted into the binary representation to each user device. Meanwhile, each user device is commanded depending on the command information converted into the binary representation to output the various sensory effects, that is, provide the multimedia contents to the users and provide the various sensory effects of the multimedia contents in real time.

For example, in the above-mentioned Part 3 of MPEG-V, the various sensory effects that may indicated the scene of the multimedia contents or the actual environment are defined a schema for effectively describing the various sensory effects. For example, when wind blows in a specific scene of a movie, the sensory effect like the wind blows is described using a predetermined schema and is inserted into the multimedia data. When the home server reproduces a movie through the multimedia data, the home server provides the sensory effect like the wind blows to the user by extracting the sensory effect information from the multimedia data and then, being synchronized with a user device capable of outputting the wind effect like a fan. Further, as another example, a trainee (that is, a user) purchasing the user devices capable of giving the various sensory effects is in the house and a lecturer (that is, a service provider) gives a lecture (that is, transmit multimedia data) from a remote and transmits the various sensory effects depending on course content (that is, multimedia contents) to a trainee, thereby providing more realistic education, that is, higher quality of multimedia services.

In order to provide the high quality of multimedia services, the sensory effect information simultaneously provided the multimedia contents may be described as an eXtensible markup language (hereinafter, referred to as “XML”) document. For example, when the service provider described the sensory effect information as the XML document, the sensory effect information is transmitted to the user server as the XML document and the user server receiving the sensory effect information on the XML document analyzes the XML document and then, analyzes the sensory effect information on the analyzed XML document.

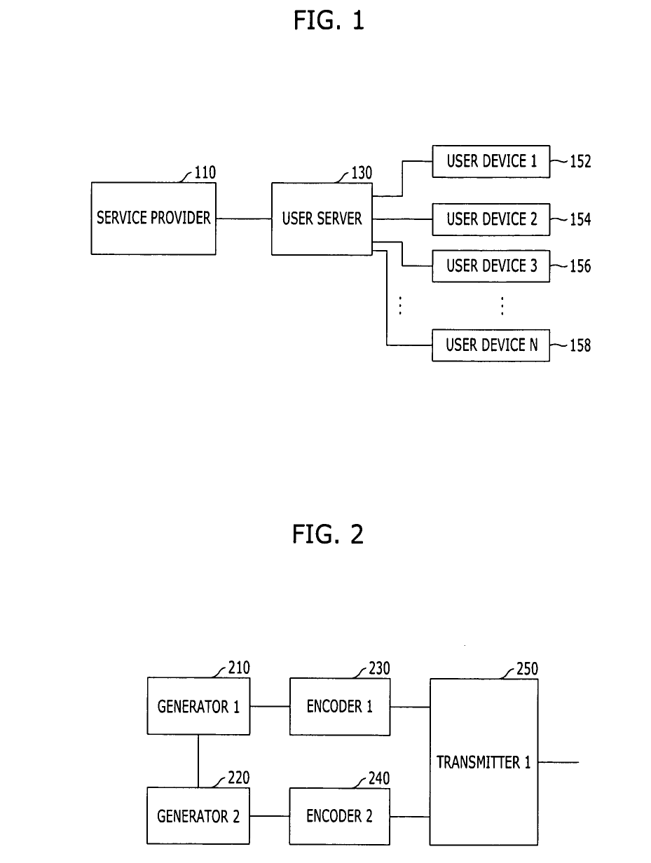

In this case, the user server may have a limitation in providing the high quality of various multimedia services to the users at high speed and in real time depending on the analysis of the XML document and the sensory effect information. However, the exemplary embodiments of the present invention encode and transmit the sensory effect information using the binary representation as described above, such that the analysis of the XML document and the sensory effect information is unnecessary and the high quality of various multimedia services are provided to the users at high speed and in real time. In other words, in the exemplary embodiments of the present invention, in Part 3 of MPEG-V, the sensory effect information is compressed and transmitted using the binary represenation encoding scheme rather than the XML document, such that the number of bits used to transmit the sensory effect information is reduced, that is, the amount of resources used to transmit the sensory effect information is reduced, and the analysis process of the XML document and the sensory effect information is omitted to effectively transmit the sensory effect information at high speed. A system for providing multimedia services in accordance with an exemplary embodiment of the present invention will be described in more detail with reference to FIG. 1.

FIG. 1 is a diagram schematically illustrating a structure of a system for providing multimedia services in accordance with an exemplary embodiment of the present invention.

Referring to FIG. 1, the system for providing multimedia services includes a service provider 110 configured to generate, provide, or sell high quality of various multimedia services that each user wants to receive depending on service requests of users, a user server 130 configured to transmit and transmit multimedia services provided from the service provider 110 to the users, a plurality of user devices, for example, a user device 1 152, a user device 2 154, a user device 3 156, and a user device N 158 configured to output the multimedia services transmitted from the user server 130 and substantially provide the output multimedia services to the users.

As described above, the service provider 110 generates the multimedia contents of the multimedia services that each user wants to receive depending on the service requests of users and generates the sensory effect information so as to provide the various sensory effects of the multimedia contents to each user. Further, the service provider 110 encodes the multimedia contents and the sensory effect information to be transmitted to the user server 130 at high speed.

As described above, the service provider 110 encodes the sensory effect information using the binary representation, that is, encodes the sensory effect information using the binary representation encoding scheme, such that the data size of the sensory effect information is minimized and the sensory effect information of the binary representation having the minimum data size is transmitted to the user server 130. Therefore, the service provider 110 maximally uses the available resources so as to provide the multimedia services to transmit the multimedia data at high speed. In particular, the service provider 110 transmits the encoded multimedia contents and the sensory effect information encoded by the binary representation as the multimedia data to the user server 130. That is, the multimedia data includes the encoded multimedia contents and the sensory effect information encoded by the binary representation and is transmitted to the user server 130.

In this case, the service provider 110 may be a contents provider generating the multimedia services or a communication provider providing or selling the multimedia services, a service vendor, or the like. The service provider 100 will be described in more detail with reference to FIG. 2 and the description thereof will be omitted.

Further, the user server 130 receives the multimedia data from the service provider 110 and transmits the multimedia contents included in the multimedia data to the corresponding user device, for example, the user device 1 152 and converts the sensory effect information encoded by the binary representation included in the multimedia data into command information to be transmitted to the corresponding user devices, for example, the user device 2 154, the user device 3 156, and the user device N 158, respectively. As described above, the user server 130 may receive the sensory effect information on the multimedia contents from the service provider 110 as the sensory effect information encoded by the binary representation, but may also receive the sensory effect information on the XML document from other general service providers in Part 3 of MPEG-V.

In this case, when the user server 130 receives the sensory effect information encoded by the binary representation, it converts the sensory effect information into the command information using the binary representation and then, encodes the converted command information using the binary representation to transmit the command information encoded by the binary representation to the user devices 152, 154, 156, and 158, respectively, or transmit the sensory effect information of the binary representation as the command information to the user devices 152, 154, 156, and 158, respectively. In addition, when the user server 130 receives the sensory effect information on the XML document, it converts the sensory effect information on the XML document into the command information and then, encodes the converted command information using the binary representation to transmit the command information encoded by the binary representation to the user devices 152, 154, 156, and 158, respectively.

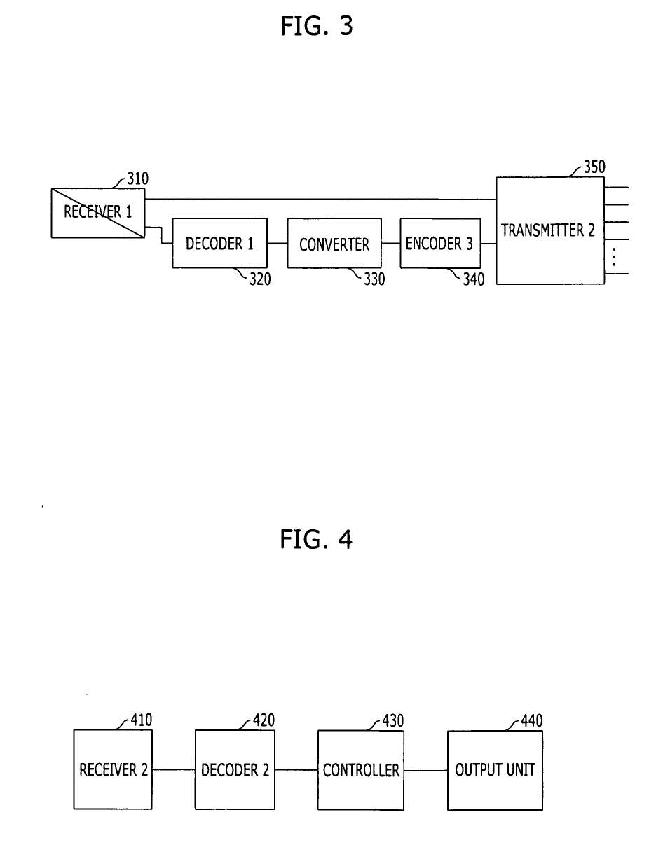

In this case, the user server 130 may be a terminal receiving the multimedia data from the service provider 110, a server, for example, a home server commanding and managing the user devices 152, 154, 156, and 158 outputting and providing the multimedia contents and the various sensory effects of the multimedia contents to the actual users, or the like. The user server 130 will be described in more detail with reference to FIG. 3 and the description thereof will be omitted.

Further, the user devices 152, 154, 156, and 158 receive the multimedia contents and the command information from the user server 130 to output, that is, provide the actual multimedia contents and the various sensory effects of the multimedia contents to each user. In this case, the user devices 152, 154, 156, and 158 include the user device that outputs the multimedia contents, that is, outputs video and audio of the multimedia contents, for example, the user device 1 152 and the user devices 154, 156, and 158 outputting the various sensory effects of the multimedia contents, respectively.

As described above, the user device 1 152 outputs the video and audio of the multimedia services that the users want to receive and provides the video and audio to the users. The remaining user devices 154, 156, and 158 each receive the command information encoded by the binary representation from the user server 130 and are commanded depending on the command information encoded by the binary representation to output the corresponding sensory effects. In particular, the remaining user devices 154, 156, and 158 is the command information outputting the sensory effect while outputting the video and audio of the multimedia services and outputs the sensory effects at high speed, corresponding to the command information encoded by the binary representation without analyzing the command information depending on the receiving of the command information encoded by the binary representation, thereby providing the sensory effects to the users in real time while outputting the video and audio of the multimedia services.

In this case, the user devices 152, 154, 156, and 158 may be a video display and a speaker that outputs video and audio, various devices outputting the various sensory effects, for example, home appliances such as a fan, an air conditioner, a humidifier, a heat blower, a boiler, or the like. That is, the user devices 152, 154, 156, and 158 are commanded depending on the command information encoded by the binary representation to provide the high quality of multimedia services to the users in real time. In other words, the user devices 152, 154, 156, and 158 provide video and audio, that is, the multimedia contents of the multimedia services and at the same time, provide the various sensory effects in real time. In this case, the various sensory effects of the multimedia contents may be, for example, a light effect, a colored light effect, a flash light effect, a temperature effect, a wind effect, a vibration effect, a water spray effect as a spraying effect, a scent effect, a fog effect, a color correction effect, a motion and feeling effect (for example, rigid body motion effect), a passive kinesthetic motion effect, a passive kinesthetic force effect, an active kinesthetic effect, a tactile effect, or the like. The user devices 152, 154, 156, and 158 will be described in more detail with reference to FIG. 4 and the detailed description thereof will be omitted.

In the system for providing multimedia services in accordance with the exemplary embodiment of the present invention, the service provider 110 generates the sensory effect information in real time depending on the multimedia contents, obtains the sensory effect information on the XML document and the service provider 110 encodes the sensory effect information using the binary representation as descried above and transmits the sensory effect information encoded by the binary representation to the user server 130 through the network.

In other words, the system for providing multimedia services in accordance with the exemplary embodiment of the present invention, the service provider 110 encodes the sensory effect information on the multimedia contents using the binary represenation encoding scheme in Part 3 of MPEG-V and transmits the sensory effect information and the multimedia contents encoded by the binary representation as the multimedia data to the user server 130. Therefore, the system for providing multimedia services maximally uses the network usable to provide the multimedia services to transmit the multimedia data, in particular, encodes the sensory effect information using the binary representation encoding scheme to minimize the data size of the sensory effect information, thereby transmitting the multimedia data to the user server 130 at high speed and in real time.

The user server 130 receives the sensory effect information encoded by the binary representation to acquire the sensory effect information for providing the high quality of various multimedia services to the users at high speed and converts the acquired sensory effect information into the command information and encodes the converted command information using the binary representation to be transmitted to each user device 152, 154, 156, and 158. In addition, each user device 152, 154, 156, and 158 is subjected to the device command depending on the command information encoded by the binary representation to simultaneously provide the various sensory effects and the multimedia contents to the users in real time. In the system for providing multimedia services in accordance with the exemplary embodiment of the present invention, the service provider 110 will be described in more detail with reference to FIG. 2.

FIG. 2 is a diagram schematically illustrating a structure of a service provider in the system for providing multimedia services in accordance with the exemplary embodiment of the present invention.

Referring to FIG. 2, the service provider 110 includes a generator 1 210 configured to generate the multimedia contents of the multimedia services that the each user want to receive depending on the service requests of users, a generator 2 220 configured to generate information representing the various sensory effects of the multimedia contents, that is, acquire the sensory effect information or the sensory effect information on the XML document, an encoder 1 230 configured to encode the multimedia contents, an encoder 2 240 configured to encode the sensory effect information using the binary representation encoding scheme, and a transmitter 1 250 configured to transmit the multimedia data including the encoded multimedia contents and the sensory effect information to the user server 130.

The generator 1 210 generates the multimedia contents corresponding to the high quality of various multimedia services that the users want to receive or receives and acquires the multimedia contents from external devices. Further, the generator 2 220 generates the sensory effect information on the multimedia contents so as to provide the various sensory effects while the multimedia contents or receives and acquires the sensory effect information on the XML document from the external devices, thereby providing the high quality of various multimedia services to the users.

The encoder 1 230 uses the predetermined encoding scheme to encode the multimedia contents. Further, the encoder 2 240 encodes the sensory effect information using the binary representation encoding scheme, that is, using the binary representation. In this case, the sensory effect information is encoded using the binary code in a stream form. In other words, the encoder 2 240 is a sensory effect stream encoder and outputs the sensory effect information as the sensory effect stream encoded by the binary representation.

In this case, the encoder 2 240 defines syntax, binary representation, and semantics of the sensory effects corresponding to the sensory effect information at the time of the binary representation encoding of the sensory effect information. Further, the encoder 2 240 minimizes the data size of the sensory effect information by encoding the sensory effect information using the binary representation and as described above, the user server 130 receives the sensory effect information of the binary representation to confirm the sensory effect information through stream decoding of the binary code without analyzing the sensory effect information and converts the confirmed sensory effect information into the control information. In this case, the sensory effect information and the binary representation encoding of the sensory effect information will be described in more detail below and the detailed description thereof will be omitted.

The transmitter 1 250 transmits the multimedia data including the multimedia contents and the sensory effect information to the user server 130, that is, transmits the encoded multimedia contents and the sensory effect information encoded using the binary code to the user server 130. As described above, as the sensory effect information is transmitted while being encoded using the binary code in the stream form, that is, transmitted as the sensory effect information stream encoded by the binary representation, the transmitter 1 250 maximally uses the available resources to transmit the multimedia data to the user server 130 at high speed and in real time. In the system for providing multimedia services in accordance with the exemplary embodiment of the present invention, the service provider 130 will be described in more detail with reference to FIG. 3.

FIG. 3 is a diagram schematically illustrating a structure of a user server in the system for providing multimedia services in accordance with the exemplary embodiment of the present invention.

Referring to FIG. 3, the user server 130 includes a receiver 1 310 configured to receive the multimedia data from the service provider 110, a decoder 1 320 configured to decode the sensory effect information encoded by the binary representation in the received multimedia data as described above, a converter 330 configured to convert the decoded sensory effect information into the command information for commanding the devices of each user devices 152, 154, 156, and 158, an encoder 3 340 configured to encode the converted command information using the binary representation encoding scheme, and a transmitter 2 350 configured to transmit the multimedia contents in the multimedia data and the command information encoded by the binary representation to each user device 152, 154, 156, and 158.

As described above, the receiver 1 310 receives the multimedia data including the multimedia contents and the sensory effect information on the multimedia contents encoded by the binary representation from the service provider 110. In this case, the receiver 1 310 may also receive the multimedia data including the multimedia contents and the sensory effect information on the XML document from other service providers.

The decoder 1 320 decodes the sensory effect information encoded by the binary representation in the multimedia data. In this case, since the sensory effect information encoded by the binary representation is the sensory effect stream encoded using the binary code in the stream form, the decoder 1 320, which is a sensory effect stream decoder, decodes the sensory effect stream encoded by the binary representation and the decoded sensory effect information is transmitted to the converter 330. In addition, when the receiver 1 310 receives the multimedia data including the sensory effect information on the XML document, the decoder 1 320 analyzes and confirms the sensory effect information on the XML document and transmits the confirmed sensory effect information to the converter 330.

The converter 330 converts the sensory effect information into the command information for commanding the devices of the user devices 152, 154, 156, and 158. In this case, the converter 330 converts the sensory effect information into the command information in consideration of the capability information on the user devices 152, 154, 156, and 158.

In this case, the receiver 1 310 of the user server 130 receives the capability information on the user devices 152, 154, 156, and 158 from all the user devices 152, 154, 156, and 158, respectively. In particular, as described above, as the user server 130 manages and controls the user devices 152, 154, 156, and 158, the user devices 152, 154, 156, and 158 each transmit the capability information to the user server 130 at the time of the initial connection and setting to the user server 130 of the user devices 152, 154, 156, and 158 for providing the multimedia services.

Therefore, the converter 330 converts the sensory information into the command information so as to allow the user devices 152, 154, 156, and 158 to accurately output the sensory effects indicated by the sensory effect information in consideration of the capability information, that is, accurately provide the sensory effect of the multimedia contents depending on the sensory effect information to the users in real time and the user devices 152, 154, 156, and 158 accurately provides the sensory effect of the multimedia contents to the users in real time by the device command of the command information.

The encoder 3 340 encodes the converted command information using the binary encoding scheme, that is, encodes the command information using the binary representation. In this case, the command information is encoded using the binary code in the stream form. In other words, the encoder 3 340 becomes the device command stream encoder and outputs the command information for commanding the devices as the device command stream encoded by the binary representation.

Further, as the command information is encoded by the binary representation, the command information of the binary representation becomes each user device 152, 154, 156, and 158. The user devices 152, 154, 156, and 158 each receive the command information of the binary representation to perform the device command through the stream decoding of the binary code without analyzing the command information, thereby outputting the sensory effect. In addition, as described above, the receiver 1 310 of the user server 130 receives the sensory information on the multimedia contents from the service provider 110 as the sensory effect information encoded by the binary representation and the sensory effect information on the XML document.

In more detail, when the receiver 1 310 receives the sensory effect information encoded by the binary representation, as described above, the decoder 1 320 performs stream decoding on the sensory effect information encoded by the binary representation and the converter 330 converts the sensory effect information into the command information in consideration of the capability information on the user devices 152, 154, 156, and 158 and then, the encoder 3 340 encodes the converted command information using the binary representation, wherein the command information encoded by the binary representation are transmitted to the user devices 152, 154, 156, and 158, respectively.

Further, when the receiver 1 310 receives the sensory effect information encoded by the binary representation, as described above, the user server 130 transmits the sensory effect information of the binary representation as the command information to the user devices 152, 154, 156, and 158, respectively, the decoder 1 320 performs the stream decoding on the sensory effect information encoded by the binary representation and does not perform the command information conversion operation in the converter 330 and the encoder 3 340 encodes the decoded sensory effect information using the binary representation in consideration of the capability information of the user devices 152, 154, 156, and 518. In other words, the encoder 3 340 outputs the sensory effect information of the binary representation encoded in consideration of the capability information as the command information encoded by the binary representation for performing the device command of the user devices 152, 154, 156, and 158, respectively, wherein the command information encoded by the binary representation is transmitted to the user devices 152, 154, 156, and 158, respectively.

Further, when the receiver 1 310 receives the sensory effect information of the XML document, the decoder 1 320 analyzes and confirms the sensory effect information of the XML document and the converter 330 converts the confirmed sensory effect information into the command information in consideration of the capability information of the user devices 152, 154, 156, and 158 and then, the encoder 3 340 encodes the converted command information using the binary representation, wherein the command information encoded by the binary representation are transmitted to the user devices 152, 154, 156, and 518, respectively.

For example, when the user server 130 receives the sensory effect information of the binary representation or the sensory effect information of the XML document including a two-level wind effect (as an example, wind blowing of 2 m/s magnitude), the user server 130 confirms the user device providing the wind effect through the capability information of the user devices 152, 154, 156, and 158, for example, confirms a fan and transmits the device command so as for the fan to output the two-level wind effect through the capability information of the fan, that is, the command information of the binary representation commanding the fan to be operated as three level (herein, the user server 130 confirms that the fan outputs the wind at a size of 2 m/s when being operated at 3 level through the capability information of the fan) to the fan. Further, the fan receives the command information of the binary representation from the user server 130 and then, decodes the command information of the binary representation to be operated as three level, such that the users receives the effect like the wind having a size of 2 m/s blows in real time while viewing the multimedia contents.

The transmitter 2 350 transmits the multimedia contents included in the multimedia data and the command information encoded by the binary representation to the user devices 152, 154, 156, and 158, respectively. In this case, the command information encoded by the binary representation is transmitted to the user devices 152, 154, 156, and 158 in the stream form. The user devices 152, 154, 156, and 158 in the system for providing multimedia services in accordance with the exemplary embodiment of the present invention will be described in more detail with reference to FIG. 4.

FIG. 4 is a diagram schematically illustrating a structure of a user device in the system for providing multimedia services in accordance with the exemplary embodiment of the present invention.

Referring to FIG. 4, the user device includes a receiver 2 410 configured to receive the multimedia contents or the command information encoded by the binary representation from the user server 130, a decoder 2 420 configured to decode the multimedia contents or the command information encoded by the binary representation, a controller 430 configured to perform the device command depending on the decoded command information, and an output unit 440 configured to provide the high quality of various multimedia services to the user by outputting the multimedia contents or the various sensory effects of the multimedia contents.

The receiver 2 410 receives the multimedia contents transmitted from the transmitter 2 350 of the user server 130 or receives the command information encoded by the binary representation. In this case, the command information encoded by the binary representation is transmitted in the stream form and the receiver 2 410 receives the command information stream encoded by the binary representation. In addition, as described above, when the user device uses the user device outputting the multimedia contents, that is, video and audio of the multimedia services, the receiver 2 410 receives the multimedia contents and the decoder 420 decodes the multimedia contents and then, the output unit 440 outputs the multimedia contents, that is, the video and audio of the multimedia services to the user. Hereinafter, for convenience of explanation, the case in which the receiver 410 receives the command information encoded by the binary representation, that is, the case in which the user device is a device providing the various sensory effects of the multimedia contents to the users will be mainly described.

The decoder 2 420 decodes the command information of the binary representation received in the stream form. In this case, since the command information encoded by the binary representation is the command information stream encoded by the binary code in the stream form, the decoder 2 420, which is the device command stream decoder, decodes the command information stream encoded by the binary representation and transmits the decoded command information as the device command signal to the controller 430.

The controller 430 receives the command information as the command signal from the decoder 2 420 and performs the device command depending on the command information. That is, the controller 420 controls the user device to provide the sensory effect of the multimedia contents to the user depending on the command information. In this case, the sensory effects are output at high speed by transmitting the command information is encoded without performing the analysis and confirmation of the command information by the binary representation from the user server 130, such that the user device simultaneously provides the sensory effects and the multimedia contents to the users in real time.

In other words, when the receive 2 410 receives the command information of the XML document, the decoder 2 420 analyzes and confirms the command information of the XML document and the controller 430 outputs the sensory effect through the device command depending on the confirmed command information. In this case, the sensory effects may not be output at high speed by performing the analysis and confirmation of the command information, such that the user device does not simultaneously provide the sensory effect and the multimedia contents to the users in real time. However, since the user server 130 of the multimedia service providing system in accordance with the exemplary embodiment of the present invention encodes the command information using the binary representation in consideration of the capability information of the user devices 152, 154, 156, and 158 to be transmitted to the user devices 152, 154, 156, and 158, respectively, each user device 152, 154, 156, and 158 outputs the sensory effects at high speed without performing the analysis and confirmation operations of the command information, such that each user device 152, 154, 156, and 158 simultaneously provides the sensory effects and the multimedia contents to the users in real time.

The output unit 440 outputs the sensory effects of the multimedia contents, corresponding to the device command depending on the command information of the binary representation. Hereinafter, the sensory effect and the sensory effect information of the multimedia contents and the encoding of the sensory effect binary representation of the service user 110 will be described in more detail.

First, describing the sensory effect information, that is, the base data types and the elements of the sensory effect metadata, the syntax may be represented as the following Table 1. Herein, Table 1 is a table representing the syntax of the sensory effect metadata.

```
TABLE 1
<!-- ################################################ -->
  <!-- SEM Base Attributes -->
  <!-- ################################################ -->
  <attributeGroup name=“SEMBaseAttributes”>
    <attribute name=“activate” type=“boolean” use=“optional” />
```

| | |
|---|---|
| <attribute name=“duration” | type=“positiveInteger” |

```
use=“optional” />
    <attribute name=“fade” type=“positiveInteger” use=“optional”
/>
    <attribute name=“alt” type=“anyURI” use=“optional” />
```

| | |
|---|---|
| <attribute name=“priority” | type=“positiveInteger” |

```
use=“optional” />
    <attribute name=“location” type=“mpeg7:termReferenceType”
        use=“optional”/>
    <attributeGroup ref=“sedl:SEMAdaptabilityAttributes”/>
</attributeGroup>
  <simpleType name=“intensityValueType”>
    <restriction base=“float”/>
  </simpleType>
  <simpleType name=“intensityRangeType”>
    <restriction>
      <simpleType>
        <list itemType=“float”/>
      </simpleType>
      <length value=“2” fixed=“true”/>
    </restriction>
  </simpleType>
  <!-- ################################################ -->
  <!-- SEM Adaptability Attributes -->
  <!-- ################################################ -->
  <attributeGroup name=“SEMAdaptabilityAttributes”>
```

| | |
|---|---|
| <attribute name=“adaptType” | type=“sedl:adaptTypeType” |
| use=“optional”/> | |
| <attribute name=“adaptRange” | type=“sedl:adaptRangeType” |

```
default=“10”
            use=“optional”/>
  </attributeGroup>
  <simpleType name=“adaptTypeType”>
    <restriction base=“NMTOKEN”>
      <enumeration value=“Strict”/>
      <enumeration value=“Under”/>
      <enumeration value=“Over”/>
      <enumeration value=“Both”/>
    </restriction>
  </simpleType>
  <simpleType name=“adaptRangeType”>
    <restriction base=“unsignedInt”>
      <minInclusive value=“0”/>
      <maxInclusive value=“100”/>
    </restriction>
  </simpleType>
  <!-- ################################################ -->
  <!-- SEM Base type -->
  <!-- ################################################ -->
  <complexType name=“SEMBaseType” abstract=“true”>
    <complexContent>
      <restriction base=“anyType”>
        <attribute name=“id” type=“ID” use=“optional”/>
      </restriction>
    </complexContent>
  </complexType>
```

Further, the binary encoding representation scheme or the binary representation of the base datatypes and the elements of the sensory effect metadata may be represented as the following Table 2. In this case, Table 2 is a table representing the binary representation of the base datatypes and the elements of the sensory effect metadata.

TABLE 2

| | | Number of | |
|---|---|---|---|
| SEMBaseAttributes{ | | Bits | Mnemonic |
| | activateFlag | 1 | bslbf |
| | durationFlag | 1 | bslbf |
| | fadeFlag | 1 | bslbf |
| | altFlag | 1 | bslbf |
| | priorityFlag | 1 | bslbf |
| | locationFlag | 1 | bslbf |
| | if(activateFlag) { | | |

| | | |
|---|---|---|
| activate | 1 | bslbf |

}
if(durationFlag) {

| | | |
|---|---|---|
| duration | 32 | uimsbf |

}
if(fadeFlag) {

| | | |
|---|---|---|
| fade | 32 | uimsbf |

}
if(altFlag) {

| | |
|---|---|
| alt | UTF-8 |

}
if(priority-Flag) {

| | | |
|---|---|---|
| priority | 32 | uimsbf |

}
if(locationFlag) {

| | | |
|---|---|---|
| location | 7 | bslbf (Table1) |

| | |
|---|---|
| } | |
| SEMAdaptabilityAttributes | SEMAdaptabilityAttributes |

}
SEMAdaptabilityAttributes {

| | | |
|---|---|---|
| adaptTypeFlag | 1 | bslbf |

if(adaptTypeFlag) {

| | | |
|---|---|---|
| adaptType | 2 | bslbf (Table2) |

| | | |
|---|---|---|
| } | | |
| adaptRange | 7 | uimsbf |

}
SEMBaseType{

| | | |
|---|---|---|
| idFlag | 1 | bslbf |
| if(idFlag) { | | |

| | | |
|---|---|---|
| id | See ISO | UTF-8 |

10646

}

}

Further, the semantics of the base datatypes and the elements of the sensory effect metadata may be represented as the following Table 3. Herein, Table 3 is a table representing the semantics of the SEM base attributes.

TABLE 3

| Name | Definition |
|---|---|
| activateFlag | When a flag value representing whether active |
| | attribute is used is 1, active attribute is |
| | used (This field signals the presence of |
| | active attribute. If it is set to “1” the |
| | active attribute is following.) |
| durationFlag | When a flag value representing whether |
| | duration attribute is used is 1, duration |
| | attribute is used (This field signals the |
| | presence of duration attribute. If it is set |
| | to “1” the duration attribute is following). |
| fadeFlag | When a flag value representing whether fade |
| | attribute is used is 1, fade attribute is |
| | used (This field signals the presence of fade |
| | attribute. If it is set to “1” the fade |
| | attribute is following). |
| altFlag | When a flag value representing whether alt |
| | attribute is used is 1, alt attribute is used |
| | (This field signals the presence of alt |
| | attribute. If it is set to “1” the alt |
| | attribute is following). |
| priorityFlag | When a flag value representing whether |
| | priority attribute is used is 1, priority |
| | attribute is used (This field signals the |
| | presence of priority attribute. If it is set |
| | to “1” the priotiry attribute is following). |
| locationFlag | When a fflag value representing whether |
| | location attribute is used is 1, location |
| | attribute is used (This field signals the |
| | presence of location attribute. If it is set |
| | to “1” the location attribute is following). |
| activate | Describe whether an effect is activated, if |
| | true, describe that an effect is activated |
| | (Describes whether the effect shall be |
| | activated. A value of true means the effect |
| | shall be activated and false means the effect |
| | shall be deactivated). |
| duration | Describe a duration time of effect by |
| | positive integer (Describes the duration |
| | according to the time scheme used. The time |
| | scheme used shall be identified by means of |
| | the si:absTimeScheme and si:timeScale |
| | attributes respectively). |
| fade | Describe a fading time by a positive integer |
| | (Describes the fade time according to the |
| | time scheme used within which the defined |
| | intensity shall be reached. The time scheme |
| | used shall be identified by means of the |
| | si:absTimeScheme and si:timeScale attributes |
| | respectively). |
| alt | Describe an alternative effect identified by |
| | URI. |
| | NOTE 1 The alternative might point to an |
| | effect - or list of effects - within the same |
| | description or an external description. |
| | NOTE 2 The alternative might be used in case |
| | the original effect cannot be processed. |

pri

Describe relative priority for other effects
by positive integer. Describe highest priority
when a value is 1 (Describes the priority for effects with respect to other effects in the same group of effects sharing the same point in time when they should become available for consumption. A value of one indicates the highest priority and larger values indicate lower priorities.
NOTE 3 The priority might by used to process effects—Flag within a group of effects—according to the capabilities of the adaptation VR).

| | |
|---|---|
| EXAMPLE 2 The | |
| adaptation VR | |
| processes the | |
| individual effects | |
| of a group of | |
| effects according | |
| to their priority | |
| in descending | |
| order due to its | |
| limited | |
| capabilities. | |
| That is, effects | |
| with low priority | |
| might get lost. | |
| location | Represent location at which effect is |
| | provided. Eleven locations are each |
| | allocated by binary code as the following |
| | figures (Describes the location from where |
| | the effect is expected to be received from |
| | the user' perspective according to the x-, y-, |
| | and z-axis as depicted in location model |
| | for sensory effect metadata. |
| | A classification scheme that may be used for |
| | this purpose is the LocationCS as Flag in |
| | Annex A.2.1. The terms from the LocationCS |
| | shall be concatenated with the “:” sign in |
| | order of the x-, y-, and z-axis to uniquely |
| | define a location within the three- |
| | dimensional space. |
| | For referring to a group of locations, a wild |
| | card mechanism may be employed using the “*” |
| | sign. |
| | EXAMPLE 4 urn:mpeg:mpeg-v:01-SI-LocationCS- |
| | NS:center:middle:front defines the location |
| | as follows: center on the x-axis, middle on |
| | the y-axis, and front on the z-axis. That |
| | is, it describes all effects at the center, |
| | middle, front side of the user. |
| | EXAMPLE 5 urn:mpeg:mpeg-v:01-SI-LocationCS- |
| | NS:left:*:midway defines the location as |
| | follows: left on the x-axis, any location on |
| | the y-axis, and midway on the z-axis. That |
| | is, it describes all effects at the left, |
| | midway side of the user. |
| | EXAMPLE 6 urn:mpeg:mpeg-v:01-SI-LocationCS- |
| | NS:*:*:back defines the location as follows: |
| | any location on the x-axis, any location on |
| | the y-axis, and back on the z-axis. That is, |
| | it describes all effects at the back of the |
| | user. |
| | In the binary description, the following |
| | mapping table is used location. |

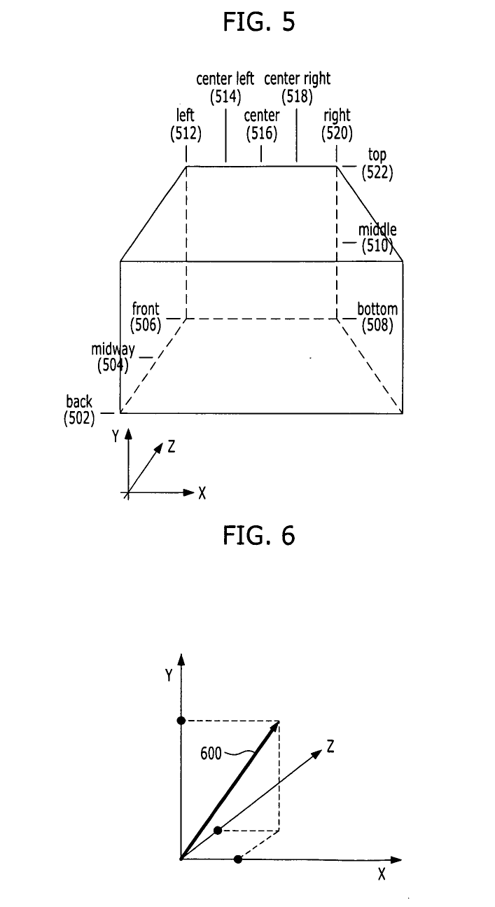

In the semantics of SEM base attributes represented in Table 3, the location uses a location mode for sensory effect metadata of the sensory effect metadata as illustrated in FIG. 5. In this case, FIG. 5 is a diagram illustrating the location model of the sensory effect metadata in the system for providing multimedia services in accordance with the exemplary embodiment of the present invention.

That is, as illustrated in FIG. 5, the location model of the sensory effect metadata include a back 502, a midway 504, a front 506, a bottom 508, a middle 510, a left 512, a centerleft 514, a center 516, a centerlight 518, a right 520, and a top 522, on a spatial coordinate of xyz. In this case, the positional model of the sensory effect metadata may include a location illustrated in FIG. 5 and may include more locations by being more subdivided on the spatial coordinate of xyz.

Further, as illustrated in FIG. 5, each location at the location model of the sensory effect metadata on the spatial coordinate of xyz may be represented by the binary representation as illustrated in FIG. 4. That is, in the semantics of the SEM base attributes represented in Table 3, the location is encoded by the binary representation. In this case, Table 4 is a table representing the binary representation of the location on the spatial coordinate of xyz.

TABLE 4

| location | term of location |
|---|---|
| 0000000 | *:*:* |
| 0000001 | left:*:* |
| 0000010 | centerleft:*:* |
| 0000011 | center:*:* |
| 0000100 | centerright:*:* |
| 0000101 | right:*:* |
| 0000110 | *:bottom:* |
| 0000111 | *:middle:* |
| 0001000 | *:top:* |
| 0001001 | *:*:back |
| 0001010 | *:*:midway |
| 0001011 | *:*:front |
| 0001100 | left:bottom:* |
| 0001101 | centerleft:bottom:* |
| 0001110 | center:bottom:* |
| 0001111 | centerright:bottom:* |
| 0010000 | right:bottom:* |
| 0010001 | left:middle:* |
| 0010010 | centerleft:middle:* |
| 0010011 | center:middle:* |
| 0010100 | centerright:middle:* |
| 0010101 | right:middle:* |
| 0010110 | left:top:* |
| 0010111 | centerleft:top:* |
| 0011000 | center:top:* |
| 0011001 | centerright:top:* |
| 0011010 | right:top:* |
| 0011011 | left:*:back |
| 0011100 | centerleft:*:back |
| 0011101 | center:*:back |
| 0011110 | centerright:*:back |
| 0011111 | right:*:back |
| 0100000 | left:*:midway |
| 0100001 | centerleft:*:midway |
| 0100010 | center:*:midway |
| 0100011 | centerright:*:midway |
| 0100100 | right:*:midway |
| 0100101 | left:*:front |
| 0100110 | centerleft:*:front |
| 0100111 | center:*:front |
| 0101000 | centerright:*:front |
| 0101001 | right:*:front |
| 0101010 | *:bottom:back |
| 0101011 | *:middle:back |
| 0101100 | *:top:back |
| 0101101 | *:bottom:midway |
| 0101110 | *:middle:midway |
| 0101111 | *:top:midway |
| 0110000 | *:bottom:front |
| 0110001 | *:middle:front |
| 0110010 | *:top:front |
| 0110011 | left:bottom:back |
| 0110100 | centerleft:bottom:back |
| 0110101 | center:bottom:back |
| 0110110 | centerright:bottom:back |
| 0110111 | right:bottom:back |
| 0111000 | left:middle:back |
| 0111001 | centerleft:middle:back |
| 0111010 | center:middle:back |
| 0111011 | centerright:middle:back |
| 0111100 | right:middle:back |
| 0111101 | left:top:back |
| 0111110 | centerleft:top:back |
| 0111111 | center:top:back |
| 1000000 | centerright:top:back |
| 1000001 | right:top:back |
| 1000010 | left:bottom:midway |
| 1000011 | centerleft:bottom:midway |
| 1000100 | center:bottom:midway |
| 1000101 | centerright:bottom:midway |
| 1000110 | right:bottom:midway |
| 1000111 | left:middle:midway |
| 1001000 | centerleft:middle:midway |
| 1001001 | center:middle:midway |
| 1001010 | centerright:middle:midway |
| 1001011 | right:middle:midway |
| 1001100 | left:top:midway |
| 1001101 | centerleft:top:midway |
| 1001110 | center:top:midway |
| 1001111 | centerright:top:midway |
| 1010000 | right:top:midway |
| 1010001 | left:bottom:midway |
| 1010010 | centerleft:bottom:midway |
| 1010011 | center:bottom:midway |
| 1010100 | centerright:bottom:midway |
| 1010101 | right:bottom:midway |
| 1010110 | left:middle:midway |
| 1010111 | centerleft:middle:midway |
| 1011000 | center:middle:midway |
| 1011001 | centerright:middle:midway |
| 1011010 | right:middle:midway |
| 1011011 | left:top:midway |
| 1011100 | centerleft:top:midway |
| 1011101 | center:top:midway |
| 1011110 | centerright:top:midway |
| 1011111 | right:top:midway |
| 1100000~1111111 | Reserved |

Further, the semantics of the base data types and the elements of the sensory effect metadata may be represented as the following Table 5. Herein, Table 5 is a table representing the semantics of the SEM adaptability attributes.

TABLE 5

| Name | Definition |
|---|---|
| adaptTypeFlag | This field signals the presence of adaptType |
| | attribute. If it is set to “1” the adaptType |
| | attribute is following. |
| adaptType | Describes the preferred type of adaptation |
| | with the following possible instantiations: |
| | Strict: An adaptation by approximation may |
| | not be performed. |
| | Under: An adaptation by approximation may be |
| | performed with a smaller effect value than |
| | the specified effect value. |
| | Over: An adaptation by approximation may be |
| | performed with a greater effect value than |
| | the specified effect value. |
| | Both: An adaptation by approximation may be |
| | performed between the upper and lower bound |
| | specified by adaptRange. |
| adaptRange | Describes the upper and lower bound in |
| | percentage for the adaptType. If the |
| | adaptType is not present, adaptRange shall be |
| | ignored. The value of adaptRange shoud be |
| | between 0 and 100. |
| adaptRangeFlag | When the falg vaue representing whether adapt |
| | attribute is used is 1, adaptRange attribute |
| | is used |

In the semantics of the SEM adaptability represented in Table 5, an adapt type may be represented as the following Table 6 and the binary representation is encoded. Herein, Table 6 is a table representing the binary representation of the adapt type.

TABLE 6

| adaptType | Sementics |
|---|---|
| 00 | Strict |
| 01 | Under |
| 10 | Over |
| 11 | Both |

Further, the semantics of the base data types and the elements of the sensory effect metadata may be represented as the following Table 7. Herein, Table 7 is a table representing the semantics of the SEM base type.

TABLE 7

| Name | Definition |
|---|---|
| SEMBaseType | Provides the topmost type of the base type |
| | hierarchy. |
| id | Identifies the id of the SEMBaseType. |
| idFlag | This field signals the presence of id |
| | attribute. If it is set to “1” the id |
| | attribute is following. |

Next, describing the sensory effect information, that is, the root element of the sensory effect metadata, the syntax may be represented as the following Table. Herein, Table 8 is a table representing the syntax of the root element.

```
TABLE 8
<!-- ################################################ -->
  <!-- Definition of the SEM root element -->
  <!-- ################################################ -->
  <element name=“SEM”>
    <complexType>
      <sequence>
        <element name=“DescriptionMetadata”
type=“sedl:DescriptionMetadataType”
            minOccurs=“0” maxOccurs=“1”/>
        <choice maxOccurs=“unbounded”>
<element name=“Declarations” type=“sedl:DeclarationsType” />
<element name=“GroupOfEffects”
type=“sedl:GroupOfEffectsType” />
<element name=“Effect” type=“sedl:EffectBaseType” />
<element name=“ReferenceEffect”  type=“sedl:ReferenceEffectType”
/>
        </choice>
      </sequence>
      <attribute name=“autoExtraction”
type=“sedl:autoExtractionType”/>
      <anyAttribute namespace=“##other” processContents=“lax”/>
    </complexType>
  </element>
  <simpleType name=“autoExtractionType”>
    <restriction base=“string”>
      <enumeration value=“audio”/>
      <enumeration value=“visual”/>
      <enumeration value=“both”/>
    </restriction>
  </simpleType>
```

Further, the binary encoding representation scheme or the binary representation of the root elements of the sensory effect metadata may be represented as the following Table 9. In this case, Table 9 is a table representing the binary representation of the root elements of the sensory effect metadata.

TABLE 9

| SEM { | | Number of bits | Mnemonic |
|---|---|---|---|
| | DescriptionMetadataFlag | 1 | bslbf |

If(DescriptionMetadataFlag){

| | |
|---|---|
| DescriptionMetadata | DescriptionMetadata |

| | |
|---|---|
| } | |
| NumOfElements | vluimsbf5 |

For (k=0;k<NumOfElements;k++){

| | | |
|---|---|---|
| ElementID | 4 | uimsbf (Table 3) |
| Element | | Element |

| | } | | |
|---|---|---|---|
| | autoExtractionID | 2 | uimsbf (Table 4) |
| | anyAttributeType | | anyAttributeType |
| } | | | |
| anyAttributeType { | | Number of bits | Mnemonic |
| | siAttibutes | | siAttributeList |
| | anyAttributeFlag | 1 | bslbf |
| | If(anyAttributeFlag) { | | |

| | | |
|---|---|---|
| SizeOfanyAttribute | | vluimsbf5 |
| anyAttribute | SizeOfanyAttribute | bslbf |

*8

}

}

In addition, the semantics of the root elements of the sensory effect metadata may be represented as the following Table 10. Herein, Table 10 is a table representing the semantics of the SEM root element.

TABLE 10

| Name | Definition |
|---|---|
| SEM | Serves as the root element for sensory |
| | effects metadata. |
| DescriptionMetadataFlag | This field, which is only present in the |
| | binary representation, indicates the presence |
| | of the DescriptionMetadata element. If it is |
| | 1 then the DescriptionMetadata element is |
| | present, otherwise the DescriptionMetadata |
| | element is not present. |
| Descri | |

Describes general information about the sensory effects metadata).

| | |
|---|---|
| EXAMPLE - Creation | |
| information or | |
| Classification | |
| Scheme Alias. | |
| NumOfElements | This field, which is only present in the |
| | binary representation, specifies the number |
| | of Element instances accommodated in the SEM. |
| Declarations | Dclare effects, group of sensory effects, or |
| | parameters. |
| Effect | Describe sensory effects. |
| GroupOfEffects | Describe group of sensory effects. |
| ReferenceEffect | Refer to sensory effect, group of sensory |
| | effects, or parameter. |
| ElementID | This field, which is only present in the |
| | binary representation, describes which SEM |
| | scheme shall be used. |
| | In the binary description, the following |
| | mapping table is used. |
| Element | Declare effects, group of sensory effects, or |
| | parameters |
| autoExtractionID | Describes whether an automatic extraction of |
| | sensory effects from the media resource, |
| | which is described by this sensory effect |
| | metadata, is preferable. The following |
| | values are available: |
| | audio: the automatic extraction of sensory |
| | effects from the audio part of the media |
| | resource, which is described by this sensory |
| | effect metadata, is preferable. |
| | visual: the automatic extraction of sensory |
| | effects from the visual part of the media |
| | resource, which is described by this sensory |
| | effect metadata, is preferable. |
| | both: the automatic extraction of sensory |
| | effects from both the audio and visual part |
| | of the media resource, which is described by |
| | this sensory effect metadata, is preferable. |
| | In the binary description, the following |
| | mapping table is used. |
| anyAttributeType | Reserved area (Type of anyAttribure) |
| siAttibutes | Make reference to follow siAttributeList |
| anyAttributeFlag | This field signals the presence of |
| | anyAttribute attribute. If it is set to “1” |
| | the anyAttribute is following. |
| SizeOfanyAttribute | Number of byte arrary for anyAttribute |
| anyAttributeType | Provides an extension mechanism for including |
| | attributes from namespaces other than the |
| | target namespace. Attributes that shall be |
| | included are the XML streaming instructions |
| | as defined in ISO/IEC 21000-7 for the purpose |
| | of identifying process units and associating |
| | time information to them. |

The element ID in the semantics of the SEM root element represented in Table 10, the scent may be represented by the binary representation as represented in the following Table 11. Herein, Table 11 is a table representing the binary representation of the element ID.

TABLE 11

| ElementID | Element |
|---|---|
| 0 | Reserved |
| 1 | Declarations |
| 2 | GroupOfEffects |
| 3 | Effect |
| 4 | ReferenceEffect |
| 5 | Parameter |
| 6~15 | Reserved |

Further, an auto extraction ID in the semantics of the SEM root element represented in Table 10, the scent may be represented by the binary representation as represented in the following Table 12. Herein, Table 12 is a table representing the binary representation of the auto extraction ID.

TABLE 12

| autoExtractionID | autoExtractionType |
|---|---|
| 00 | audio |
| 01 | visual |
| 10 | both |
| 11 | Reserved |

Herein, additionally describing an si attribute list, the XML representation syntax of the si attribute list may be first represented as the following Table 13. Table 13 is a table representing the XML representation syntax of the sensory effect metadata.

```
TABLE 13
<?xml version=“1.0”?>
<!-- Digital Item Adaptation ISO/IEC 21000-7 Second Edition -->
<!-- Schema for XML Streaming Instructions -->
<schema
  version=“ISO/IEC 21000-7 2nd”
  id=“XSI-2nd.xsd”
  xmlns=“http://www.w3.org/2001/XMLSchema”
  xmlns:si=“urn:mpeg:mpeg21:2003:01-DIA-XSI-NS”
  targetNamespace=“urn:mpeg:mpeg21:2003:01-DIA-XSI-NS”
  elementFormDefault=“qualified”>
  <annotation>
    <documentation>
      Declaration of attributes used for XML streaming
instructions
    </documentation>
  </annotation>
  <!-- The following attribute defines the process units -->
  <attribute name=“anchorElement” type=“boolean”/>
  <!-- The following attribute indicates that the PU shall be
encoded as Random Access Point -->
  <attribute name=“encodeAsRAP” type=“boolean”/>
  <attribute name=“puMode” type=“si:puModeType”/>
  <simpleType name=“puModeType”>
    <restriction base=“string”>
      <enumeration value=“self”/>
      <enumeration value=“ancestors”/>
      <enumeration value=“descendants”/>
      <enumeration value=“ancestorsDescendants”/>
      <enumeration value=“preceding”/>
      <enumeration value=“precedingSiblings”/>
      <enumeration value=“sequential”/>
    </restriction>
  </simpleType>
  <!-- The following attributes define the time properties -->
  <attribute name=“timeScale” type=“unsignedInt”/>
  <attribute name=“ptsDelta” type=“unsignedInt”/>
  <attribute name=“absTimeScheme” type=“string”/>
  <attribute name=“absTime” type=“string”/>
<attribute name=“pts” type=“nonNegativeInteger”/>
</schema>
```

Further, the binary encoding representation scheme or the binary representation of the syntax represented in Table 13 may be represented as the following Table 14. Herein, Table 14 is a table representing the binary representation syntax.

TABLE 14

| siAttributeList { | Number of bits | Mnemonic |
|---|---|---|
| anchorElementFlag | 1 | bslbf |
| encodeAsRAPFlag | 1 | bslbf |
| puModeFlag | 1 | bslbf |
| timeScaleFlag | 1 | bslbf |
| ptsDeltaFlag | 1 | bslbf |
| absTimeSchemeFlag | 1 | bslbf |
| absTimeFlag | 1 | bslbf |
| ptsFlag | 1 | bslbf |
| absTimeSchemeLength | | vluimsbf5 |
| absTimeLength | | vluimsbf5 |
| if(anchorElementFlag) { | | |
| anchorElement | 1 | bslbf |
| } | | |
| if(encodeAsRAPFlag) { | | |
| encodeAsRAP | 1 | bslbf |
| } | | |
| if(puModeFlag) { | | |
| puMode | 3 | bslbf (Table 5) |
| } | | |
| if(puModeFlag) { | | |
| timeScale | 32 | uimsbf |
| } | | |
| if(ptsDeltaFlag) { | | |
| ptsDelta | 32 | uimsbf |
| } | | |
| if(absTimeSchemeFlag) { | | |
| absTimeScheme | 8 * absTimeSchemeLength | bslbf |
| } | | |
| if(absTimeFlag) { | | |
| absTime | 8 * absTimeLength | bslbf |
| } | | |
| if(ptsFlag) { | | |
| pts | | vluimsbf5 |
| } | | |

In addition, the semantics of the si attribute list is represented as the following Table 15. Herein, Table 15 is a table representing the semantics of si attribute list.

TABLE 15

| Names | Description |
|---|---|
| anchorElementFlag | This field, which is only present in the |
| | binary representation, indicates the presence |
| | of the anchorElement attribute. If it is 1 |
| | then the anchorElement attribute is present, |
| | otherwise the anchorElement attribute is not |
| | present. |
| encodeAsRAPFlag | This field, which is only present in the |
| | binary representation, indicates the presence |
| | of the encodeAsRAP attribute. If it is 1 then |
| | the encodeAsRAP attribute is present, |
| | otherwise the encodeAsRAP attribute is not |
| | present. |
| puModeFlag | This field, which is only present in the |
| | binary representation, indicates the presence |
| | of the puMode attribute. If it is 1 then the |
| | puMode attribute is present, otherwise the |
| | puMode attribute is not present. |
| timeScaleFlag | This field, which is only present in the |
| | binary representation, indicates the presence |
| | of the timeScale attribute. If it is 1 then |
| | the timeScale attribute is present, otherwise |
| | the timeScale attribute is not present. |
| ptsDeltaFlag | This field, which is only present in the |
| | binary representation, indicates the presence |
| | of the ptsDelta attribute. If it is 1 then |
| | the ptsDelta attribute is present, otherwise |
| | the ptsDelta attribute is not present. |
| absTimeSchemeFlag | This field, which is only present in the |
| | binary representation, indicates the presence |
| | of the activation attribute. If it is 1 then |
| | the activation attribute is present, otherwise |
| | the activation attribute is not present. |
| absTimeFlag | This field, which is only present in the |
| | binary representation, indicates the presence |
| | of the absTimeScheme attribute. If it is 1 |
| | then the absTimeScheme attribute is present, |
| | otherwise the absTimeScheme attribute is not |
| | present. |
| ptsFlag | This field, which is only present in the |
| | binary representation, indicates the presence |
| | of the pts attribute. If it is 1 then the pts |
| | attribute is present, otherwise the pts |
| | attribute is not present. |
| absTimeSchemeLength | This field, which is only present in the |
| | binary representation, specifies the length of |
| | each absTimeSchemeLength instance in bytes. |
| | The value of this element is the size of the |
| | largest absTimeSchemeLength instance, |
| | aligned to a byte boundary by bit stuffing |
| | using 0-7 ‘1’ bits. |
| absTimeLength | This field, which is only present in the |
| | binary representation, specifies the length of |
| | each absTimeLength instance in bytes. The |
| | value of this element is the size of the |
| | largest absTimeLength instance, aligned to a |
| | byte boundary by bit stuffing using 0-7 ‘1’ |
| | bits. |
| anc | |

Describes whether the element shall be anchor element. A value of true(=1) means the element shall be anchor element and false(=0) means the element shall be not anchor element.

| | |
|---|---|
| The anchorElement | |
| allows one to | |
| indicate whether | |
| an XML element is | |
| an anchor | |
| element, i.e., | |
| the starting | |
| point for | |
| composing the | |
| process unit. | |
| encodeAsRAP | Describes property indicates that the process |
| | unit shall be encoded as a random access |
| | point. A value of true(=1) means the process |
| | unit shall be encoded as a random access point |
| | and false(=0) means the process unit shall be |
| | not encoded as a random access point. |
| puModeThe puMode | |
| specifies how | |
| elements are | |
| aggregated to the | |
| anchor element to | |
| compose the | |
| process unit. | |
| For detailed | |
| information the | |
| reader is | |
| referred to | |
| ISO/IEC JTC 1/SC | |
| 29/WG 11/N9899. | |
| PuMode = | |
| descendants means | |
| that the process | |
| unit contains the | |
| anchor element | |
| and its | |
| descendant | |
| elements. Note | |
| that the anchor | |
| elements are | |
| pictured in | |
| white. | |
| In the binary | |
| description, the | |
| following mapping | |
| table is used. | |
| timeScale | Describes a time scale. |
| ptsDelta | Describes a processing time stamp delta. |
| absTimeScheme | Describes an absolute time scheme. |
| absTime | Describes an absolute time. |
| pts | Describes a processing time stamp (PTS). |

In the semantics of the si attribute list represented in Table 15, a put mode may be represented by the binary representation as the following Table 16. That is, in the semantics of the si attribute list represented in Table 15, the put mode is encoded by the binary representation. Herein, Table 16 is a table representing the binary representation of the put mode.

TABLE 16

| puMode | puModeType |
|---|---|
| 000 | self |
| 001 | ancestors |
| 010 | descendants |
| 011 | ancestorsDescendants |
| 100 | preceding |
| 101 | precedingSiblings |
| 110 | sequential |
| 111 | Reserved |

Next, describing the sensory effect information, that is, the description metadata of the sensory effect metadata, the syntax may be represented as the following Table 17. Herein, Table 17 is a table representing the description metadata syntax.

```
TABLE 17
<!-- ################################################ -->
  <!-- Definition of Description Metadata Type -->
  <!-- ################################################ -->
  <complexType name=“DescriptionMetadataType”>
    <complexContent>
      <extension base=“mpeg7:DescriptionMetadataType”>
        <sequence>
          <element name=“ClassificationSchemeAlias” minOccurs=“0”
            maxOccurs=“unbounded”>
            <complexType>
              <complexContent>
                <extension base=“sedl:SEMBaseType”>
                  <attribute name=“alias”
type=“NMTOKEN” use=“required”/>
                  <attribute name=“href”
type=“anyURI” use=“required”/>
                </extension>
              </complexContent>
            </complexType>
          </element>
        </sequence>
      </extension>
    </complexContent>
  </complexType>
```

Further, the binary encoding representation scheme or the binary representation of the description metadata of the sensory effect metadata may be represented as the following Table 18. Herein, Table 18 is a table representing the binary representation of the description metadata of the sensory effect metadata.

TABLE 18

| | Number of | |
|---|---|---|
| DescriptionMetadata{ | bits | Mnemonic |
| MPEG7DescriptionMetadata | 1 | Mpeg7:DescriptionMeta- |
| | | dataType |
| NumOfClassSchemeAlias | | vluimsbf5 |
| for(k=0; | | |
| k<NumOfClassSchemeAlias;k++){ | | |
| SEMBaseType[k] | | SEMBaseType |
| alias[k] | | UTF-8 |
| href[k] | | UTF-8 |
| } | | |
| } | | |

In addition, the semantics of the description metadata of the sensory effect metadata may be represented as the following Table 19. Herein, Table 19 is a table representing the semantics of the description metadata.

TABLE 19

| Name | Definition |
|---|---|
| DescriptionMetadata | mpeg7:DescriptionMetadataTyp(DescriptionMetadataType |
| | extends |
| | mpeg7:DescriptionMetadataType and provides |
| | a sequence of classification schemes for |
| | usage in the SEM description). |
| MPEG7DescriptionMetadata | make reference to MPEG7:DescriptionMetadata |
| NumOfClassSchemeAlias | This field, which is only present in the |
| | binary representation, specifies the number |
| | of Classification Scheme Alias instances |
| | accommodated in the description metadata. |
| SEMBase | Describes a base type of a Sensory Effect |
| | Metadata. |
| ClassificationSchemeAlias | classification scheme referenced by URI |
| alias | Alias allocated to ClassificationScheme |
| | (Describes the alias assigned to the |
| | ClassificationScheme). The scope of the |
| | alias assigned shall be the entire |
| | description regardless of where the |
| | ClassificationSchemeAlias appears in the |
| | description |
| href | Refer to alias allocated to |
| | ClassificationScheme(Describes a reference |
| | to the classification scheme that is being |
| | aliased using a URI. The classification |
| | schemes defined in this part of the ISO/IEC |
| | 23005, whether normative of informative, |
| | shall be referenced by the uri attribute of |
| | the ClassificationScheme for that |
| | classification scheme). |

Next, describing the sensory effect information, that is, the declarations of the sensory effect metadata, the syntax may be represented as the following Table 20. Herein, Table 20 is a table representing the declarations syntax.

```
TABLE 20
<!-- ################################################ -->
  <!-- Declarations type -->
  <!-- ################################################ -->
  <complexType name=“DeclarationsType”>
    <complexContent>
      <extension base=“sedl:SEMBaseType”>
        <choice maxOccurs=“unbounded”>
          <element ref=“sedl:GroupOfEffects” />
          <element ref=“sedl:Effect” />
          <element ref=“sedl:Parameter” />
        </choice>
      </extension>
    </complexContent>
  </complexType>
```

Further, the binary encoding representation scheme or the binary representation of the declarations of the sensory effect metadata may be represented as the following Table 21. Herein, Table 21 is a table representing the binary representation of the declarations of the sensory effect metadata.

TABLE 21

| Declarations{ | Number of bits | Mnemonic |
|---|---|---|
| SEMBaseType | | SEMBaseType |
| NumOfElements | | vluimsbf5 |
| For(k=0;k<NumOfElements; | | |
| k++){ | | |
| ElementID | 4 | bslbf |
| Element | | Element |
| } | | |
| } | | |

In addition, the semantics of the declarations of the sensory effect metadata may be represented as the following Table 22. Herein, Table 22 is a table representing the semantics of the declarations type.

TABLE 22

| Name | Definition |
|---|---|
| SEMBaseType | Describes a base type of a Sensory Effect |
| | Metadata. |
| NumOfElements | This field, which is only present in the |
| | binary representation, specifies the number |
| | of Element instances accommodated in the SEM. |
| Ele | |

This field, which is only present in the binary representation, describes which SEM scheme shall be used.

| | |
|---|---|
| In the binary | |
| description, make | |
| referece to Table | |
| 3. Element ID | |
| Element | |
| Effect | Refer to SEM root elements |
| GroupOfEffects | Refer to SEM root elements |
| Parameter | Parametr of sensory effects |

Next, describing the sensory effect information, that is, the group of effects of the sensory effect metadata, the syntax may be represented as the following Table 23. Herein, Table 23 is a table representing the syntax of the group of effects.

```
TABLE 23
<!-- ################################################ -->
  <!-- Group of Effects type -->
  <!-- ################################################ -->
  <complexType name=“GroupOfEffectsType”>
    <complexContent>
      <extension base=“sedl:SEMBaseType”>
        <choice minOccurs=“2” maxOccurs=“unbounded”>
          <element ref=“sedl:Effect”/>
          <element ref=“sedl:ReferenceEffect”/>
        </choice>
        <attributeGroup ref=“sedl:SEMBaseAttributes”/>
        <anyAttribute namespace=“##other” processContents=“lax”/>
      </extension>
    </complexContent>
  </complexType>
```

Further, the binary encoding representation scheme or the binary representation of the group of effects of the sensory effect metadata may be represented as in the following Table 24. Herein, Table 24 is a table representing the binary representation of the group of effects of the sensory effect metadata.

TABLE 24

| GroupOfEffects{ | Number of bits | Mnemonic |
|---|---|---|
| SEMBaseType | | SEMBaseType |
| NumOfElements | 5 | uimsbf |
| For(k=0; | | |
| k<NumOfElements;k++){ | | |
| ElementID | 4 | bslbf |
| Element | | bslbf |
| } | | |
| SEMBaseAttributes | | SEMBaseAttributes |
| anyAttributeType | SizeOfanyAttribute * 8 | anyAttributeType |
| } | | |

In addition, the semantics of the group of effects of the sensory effect metadata may be represented as the following Table 25. Herein, Table 25 is a table representing the semantics of the group of effects type.

TABLE 25

| Name | Definition |
|---|---|
| SEMBaseType | Describes a base type of a Sensory Effect |
| | Metadata. |
| NumOfElements | This field, which is only present in the |
| | binary representation, specifies the number |
| | of Element instances accommodated in the SEM. |
| ElementIDThis | |
| field, which is | |
| only present in the | |
| binary representation, | |
| describes which | |
| SEM scheme shall | |
| be used. In the binary | |
| description, make | |
| referece to Table | |
| 3. Element ID | |
| NOTE ElementID | |
| restricted 3, 4 | |
| Element | |
| GroupOfEffectsType | Tool for representing at least two sensory |
| | effects |
| Effect | Refer to SEM root elements |
| SEMBaseAttributes | Describes a group of attributes for the |
| | effects. |
| anyAttributeType | Reserved area (Type of anyAttribure) |

Next, describing the sensory effect information, that is, the effect of the sensory effect metadata, the syntax may be represented as the following Table 26. Herein, Table 26 is a table representing the effect syntax.

```
TABLE 26
<!-- ################################################ -->
  <!-- Effect base type -->
  <!-- ################################################ -->
  <complexType name=“EffectBaseType” abstract=“true”>
    <complexContent>
      <extension base=“sedl:SEMBaseType”>
        <sequence minOccurs=“0”>
          <element name=“SupplementalInformation”
type=“sedl:SupplementalInformationType” minOccurs=“0”/>
        </sequence>
        <attribute name=“autoExtraction”
type=“sedl:autoExtractionType”/>
        <attributeGroup ref=“sedl:SEMBaseAttributes”/>
        <anyAttribute namespace=“##other” processContents=“lax”/>
      </extension>
    </complexContent>
  </complexType>
  <complexType name=“SupplementalInformationType”>
    <sequence>
      <element name=“ReferenceRegion”
type=“mpeg7:SpatioTemporalLocatorType”/>
      <element name=“Operator”
type=“sedl:OperatorType” minOccurs=“0”/>
    </sequence>
  </complexType>
  <simpleType name=“OperatorType”>
    <restriction base=“NMTOKEN”>
      <enumeration value=“Average”/>
      <enumeration value=“Dominant”/>
    </restriction>
  </simpleType>
```

Further, the binary encoding representation scheme or the binary representation of the effects of the sensory effect metadata may be represented as the following Table 27. Herein, Table 27 is a table representing the binary representation of the effects of the sensory effect metadata.

TABLE 27

| | Number of | |
|---|---|---|
| | bits | Mnemonic |
| Effect{ | | |
| EffectTypeID | 4 | uimsbf(Table 6) |
| EffectbaseType | | EffectbaseType |
| EffectType | | EffectType |
| } | | |
| EffectBaseType{ | | |
| SEMBaseType | | SEMBaseType |
| SupplementalInformationType | | SupplementalInformationType |
| Operator | 1 | bslbf |
| ReferenceRegion | | |
| autoExtractionID | 2 | uimsbf (Table 4) |
| SEMBaseAttributes | | SEMBaseAttributes |
| anyAttributeType | | anyAttributeType |
| If(anyAttributeFlag) { | | |
| SizeOfanyAttribute | | vluimsbf5 |
| anyAttribute | SizeOfanyAttribute*8 | bslbf |
| } | | |
| } | | |
| SupplementalInformationType { | | |
| ReferenceRegion | | |
| Operator | 3 | bslbf (Table 7) |
| } | | |

In the binary representation of the effects represented in Table 27, the effect type ID may be represented as the following Table 28. Herein, Table 28 is a table representing the effect type ID in the binary representation.

TABLE 28

| EffectType ID | EffectType |
|---|---|
| 0 | Reserved |
| 1 | LightType |
| 2 | FlashType |
| 3 | TemperatureType |
| 4 | WindType |
| 5 | VibrationType |
| 6 | SprayingType |
| 7 | ScentType |
| 8 | FogType |
| 9 | ColorCorrectionType |
| 10 | RigidBodyMotionType |
| 11 | PassiveKinesthetic MotionType |
| 12 | PassiveKinesthetic ForceType |
| 13 | ActiveKinestheticType |
| 14 | TactileType |
| 15 | Reserved |

In addition, the semantics of the effect of the sensory effect metadata may be represented as the following Table 29. Herein, Table 29 is a table representing semantics of the effect base type.

TABLE 29

| Name | Definition |
|---|---|
| EffectTypeID | EffectBaseType provides a basic structure of |
| | sensory effect metadata types by expanding |
| | SEMBaseType(This field, which is only present |
| | in the binary representation, specifies a |
| | descriptor identifier. The descriptor |
| | identifier indicates the descriptor type |
| | accommodated in the Effect). |
| EffectBaseType | EffectBaseType extends SEMBaseType and |
| | provides a base abstract type for a subset of |
| | types defined as part of the sensory effects |
| | metadata types. |
| SEMBaseAttributes | Describes a group of attributes for the |
| | effects. |
| anyAttributeType | Reserved area (Provides an extension |
| | mechanism for including attributes from |
| | namespaces other than the target namespace. |
| | Attributes that shall be included are the XML |
| | streaming instructions as defined in ISO/IEC |
| | 21000-7 for the purpose of identifying |
| | process units and associating time |
| | information to them). |
| | EXAMPLE - si:pts describes the point in time |
| | when the associated information shall become |
| | available to the application for processing. |

In addition, the semantics of the effects of the sensory effect metadata may be represented as the following Table 30. Herein, Table 30 is a table representing the semantics of the supplemental information type in the binary representation of the effect of the sensory effect metadata represented in Table 27.

TABLE 30

| Name | Definition |
|---|---|
| SupplementalInformationType | Describes the SupplementalInformation |
| ReferenceRegion | Describes the reference region for |
| | automatic extraction from video. If the |
| | autoExtraction is not present or is not |
| | equal to video, this element shall be |
| | ignored. The localization scheme used is |
| | identified by means of the |
| | mpeg7:SpatioTemporalLocatorType that is |
| | defined in ISO/IEC 15938-5. |
| Ope | |

Describes the preferred type of operator for extracting sensory effects from the reference region of video with the following possible instantiations.
Average: extracts sensory effects from the reference region by calculating average value.

Dominant:
extracts sensory
effects from the
reference region
by calculating
dominant value).

Further, in Table 30, the operator may be represented by the binary representation as represented in the following Table 31. That is, in the semantics of the supplemental information type represented in Table 30, the operator is encoded by the binary representation. Herein, Table 31 is a table representing the binary representation of the operator.

TABLE 31

| Operator | Sementics |
|---|---|
| 000 | Reserved |
| 001 | Average |
| 010 | Dominant |
| 011~111 | Reserved |

Next, describing the sensory effect information, that is, the reference effect of the sensory effect metadata, the syntax may be represented as the following Table 32. Herein, Table 32 is a table representing the reference effect syntax.

```
TABLE 32
<!-- ################################################ -->
  <!-- Reference Effect type -->
  <!-- ################################################ -->
  <complexType name=“ReferenceEffectType”>
    <complexContent>
      <extension base=“sedl:SEMBaseType”>
        <attribute name=“uri” type=“anyURI” use=“required” />
        <attributeGroup ref=“sedl:SEMBaseAttributes”/>
        <anyAttribute namespace=“##other”  processContents=“lax”
/>
      </extension>
    </complexContent>
  </complexType>
```

Further, the binary encoding representation scheme or the binary representation of the reference effects of the sensory effect metadata may be represented as the following Table 33. Herein, Table 33 is a table representing the binary representation of the reference effects of the sensory effect metadata.

TABLE 33

| ReferenceEffect{ | Number of bits | Mnemonic |
|---|---|---|
| SEMBaseType | | SEMBaseType |
| uri | | UTF-8 |
| SEMBaseAttributes | | SEMBaseAttributes |
| anyAttributeType | | anyAttributeType |
| anyAttributeFlag | 1 | bslbf |
| If(anyAttributeFlag) | | |
| { | | |
| SizeOfanyAttribute | | vluimsbf5 |
| anyAttribute | SizeOfanyAttribute*8 | bslbf |
| } | | |
| } | | |

In addition, the semantics of the reference effects of the sensory effect metadata may be represented as the following Table 34. Herein, Table 34 is a table representing the semantics of the reference effect type.

TABLE 34

| Name | Definition |
|---|---|
| ReferenceEffectType | Tool for describing a reference to a sensory effect |
| | group of sensory effects, or parameter. |
| uri | Describes a reference to a sensory effect, group o |
| | sensory effects, or parameter by an Uniform |
| | Resourc Identifier (URI). Its target type must be |
| | one - o - derived - of sedl:EffectBaseType |
| | sedl:GroupOfEffectType, or |
| | sedl:ParameterBaseType). |
| SEMBaseAttributes | Describes a group of attributes for the effects. |
| any | |

Reserved area (Provides an extension mechanism for including attributes from namespaces other than the target namespace. Attributes that shall be included are the XML streaming instructions as defined in ISO/IEC 21000-7 for the purpose of identifying process units and associating time information to them).
Attributes included here override the attribute values possibly defined within the sensory effect, group of effects or parameter referenced by the uri.

EXAMPLE - si:pts describes the point in time when the associate
information shall become available to the application for processing.

Next, describing the sensory effect information, that is, the parameters of the sensory effect metadata, the syntax may be represented as the following Table 35. Herein, Table 35 is a table representing the parameter syntax.

```
TABLE 35
<!-- ################################################ -->
  <!-- Parameter Base type -->
  <!-- ################################################ -->
  <complexType name=“ParameterBaseType” abstract=“true”>
    <complexContent>
      <extension base=“sedl:SEMBaseType”/>
    </complexContent>
  </complexType>
```

Further, the binary encoding representation scheme or the binary representation of the parameters of the sensory effect metadata may be represented as the following Table 36. Herein, Table 36 is a table representing the binary representation of the parameters of the sensory effect metadata.

TABLE 36

| ParameterBaseType{ | Number of bits | Mnemonic |
|---|---|---|
| SEMBaseType | | SEMBaseType |
| } | | |

In addition, the semantics of the parameters of the sensory effect metadata may be represented as the following Table 37. Herein, Table 37 is a table representing the semantics of the semantics of the parameter base type.

TABLE 37

| Name | Definition |
|---|---|
| ParameterBaseType | Provides the topmost type of the parameter |
| | base type hierarchy. |

Next, describing the sensory effect information, that is, the color correction parameter type of the sensory effect metadata, the XML representation syntax of the color correction parameter type may be first represented as the following Table 38. Table 38 is a table representing the XML representation syntax of the color correction parameter type.

```
TABLE 38
<!-- ################################################ -->
  <!-- Definition of Color Correction Parameter type -->
  <!-- ################################################ -->
  <complexType name=“ColorCorrectionParameterType”>
    <complexContent>
      <extension base=“sedl:ParameterBaseType”>
        <sequence>
          <element name=“ToneReproductionCurves”
            type=“sedl:ToneReproductionCurvesType”
minOccurs=“0”/>
          <element name=“ConversionLUT”
type=“sedl:ConversionLUTType”/>
<element name=“ColorTemperature”
type=“sedl:IlluminantType” minOccurs=“0”/>
          <element name=“InputDeviceColorGamut”
            type=“sedl:InputDeviceColorGamutType”
            minOccurs=“0”/>
          <element name=“IlluminanceOfSurround”
type=“mpeg7:unsigned12”
            minOccurs=“0”/>
        </sequence>
      </extension>
    </complexContent>
  </complexType>
  <complexType name=“ToneReproductionCurvesType”>
    <sequence maxOccurs=“256”>
      <element name=“DAC_Value” type=“mpeg7:unsigned8”/>
      <element name=“RGB_Value” type=“mpeg7:doubleVector”/>
    </sequence>
  </complexType>
  <complexType name=“ConversionLUTType”>
    <sequence>
      <element name=“RGB2XYZ_LUT”
type=“mpeg7:DoubleMatrixType”/>
      <element name=“RGBScalar_Max”
      type=“mpeg7:doubleVector”/>
      <element name=“Offset_Value” type=“mpeg7:doubleVector”/>
      <element name=“Gain_Offset_Gamma”
type=“mpeg7:DoubleMatrixType”/>
      <element name=“InverseLUT”
      type=“mpeg7:DoubleMatrixType”/>
    </sequence>
  </complexType>
  <complexType name=“IlluminantType”>
    <choice>
      <sequence>
<element name=“XY_Value” type=“dia:ChromaticityType”/>
<element name=“Y_Value” type=“mpeg7:unsigned7”/>
      </sequence>
<element name=“Correlated_CT” type=“mpeg7:unsigned8”/>
    </choice>
  </complexType>
  <complexType name=“InputDeviceColorGamutType”>
    <sequence>
      <element name=“IDCG_Type” type=“string”/>
      <element name=“IDCG_Value”
      type=“mpeg7:DoubleMatrixType”/>
    </sequence>
</complexType>
```

Further, the binary encoding representation scheme or the binary representation of the syntax represented in Table 38 may be represented as the following Table 39. Herein, Table 39 is a table representing the binary representation syntax.

TABLE 39

| | (Number of | |
|---|---|---|
| | bits) | (Mnemonic) |
| ColorCorrectionParameterType { | | |
| ParameterBaseType | | ParameterBaseType |
| ToneReproductionFlag | 1 | bslbf |
| ColorTemperatureFlag | 1 | bslbf |
| InputDeviceColorGamutFlag | 1 | bslbf |
| IlluminanceOfSurroundFlag | 1 | bslbf |
| if(ToneReproductionFlag) { | | |
| ToneReproductionCurves | | ToneReproductionCurvesType |
| } | | |
| ConversionLUT | | ConversionLUTType |
| if(ColorTemperatureFlag) { | | |
| ColorTemperature | | IlluminantType |
| } | | |
| if(InputDeviceColorGamutFlag) { | | |
| InputDeviceColorGamut | | InputDeviceColorGamutType |
| } | | |
| if(IlluminanceOfSurroundFlag) { | | |
| IlluminanceOfSurround | 12 | uimsbf |
| } | | |
| } | | |
| ToneReproductionCurvesType { | | |
| NumOfRecords | 8 | uimsbf |
| for(i=0;i< | | |
| NumOfRecords;i++){ | | |
| DAC_Value | 8 | mpeg7:unsigned8 |
| RGB_Value | 32*3 | mpeg7:doubleVector |
| } | | |
| } | | |
| ConversionLUTType { | | |
| RGB2XYZ_LUT | 32*3*3 | mpeg7:DoubleMatrixType |
| RGBScalar_Max | 32*3 | mpeg7:doubleVector |
| Offset_Value | 32*3 | mpeg7:doubleVector |
| Gain_Offset_Gamma | 32*3*3 | mpeg7:DoubleMatrixType |
| InverseLUT | 32*3*3 | mpeg7:DoubleMatrixType |
| } | | |
| IlluminantType { | | |
| ElementType | 2 | bslbf (Table 8) |
| if(ElementType==00){ | | |
| XY_Value | 32*2 | dia:ChromaticityType |
| Y_Value | 7 | uimsbf |
| }else | | |
| if(ElementType==01){ | | |
| Correlated_CT | 8 | uimsbf |
| } | | |
| } | | |
| InputDeviceColorGamutType { | | |
| typeLength | | vluimsbf5 |
| IDCG_Type | 8 * typeLength | bslbf |
| IDCG_Value | 32*3*2 | mpeg7:DoubleMatrixType |
| } | | |

In addition, the semantics of the color correction parameter type are represented as in the following Table 40. Herein, Table 40 is a table representing the semantics of the color correction parameter type.

TABLE 40

| Names | Description |
|---|---|
| ParameterBaseType | Describes a base type of a Parameter |
| | Metadata. |
| ToneReproductionFlag | This field, which is only present in the |
| | binary representation, indicates the |
| | presence of the ToneReproductionCurves |
| | element. If it is 1 then the |
| | ToneReproductionCurves element is |
| | present, otherwise the |
| | ToneReproductionCurves element is not |
| | present. |
| ColorTemperatureFlag | This field, which is only present in the |
| | binary representation, indicates the |
| | presence of the ColorTemperature |
| | element. If it is 1 then the |
| | ColorTemperature element is present, |
| | otherwise the ColorTemperature |
| | element is not present. |
| InputDeviceColorGamutFlag | This field, which is only present in the |
| | binary representation, indicates the |
| | presence of the InputDeviceColorGamut |
| | element. If it is 1 then the |
| | InputDeviceColorGamut element is |
| | present, otherwise the |
| | InputDeviceColorGamut |
| | element is not present. |
| IlluminanceOfSurroundFlag | This field, which is only present in the |
| | binary representation, indicates the |
| | presence of the IlluminanceOfSurround |
| | element. If it is 1 then the |
| | IlluminanceOfSurround element is present, |
| | otherwise the IlluminanceOfSurround |
| | element is not present. |
| ToneReproductionCurves | This curve shows the characteristics |
| | (e.g., gamma curves for R, G and B |
| | channels) of the input display device. |
| ConversionLUT | A look-up table (matrix) converting an |
| | image between an image color space (e.g. |
| | RGB) and a standard connection space |
| | (e.g. CIE XYZ). |
| ColorTemperature | An element describing a white point |
| | setting (e.g., D65, D93) of the input |
| | display device. |
| InputDeviceColorGamut | An element describing an input display |
| | device color gamut, which is represented |
| | by chromaticity values of R, G, and B |
| | channels at maximum DAC values. |
| IlluminanceOfSurround | An element describing an illuminance |
| | level of viewing environment. The |
| | illuminance is represented by lux. |

Further, in the semantics of the color correction parameter type represented in Table 40, the semantics of the ton reproduction curves are represented as the following Table 41. Herein, Table 41 is a table representing the semantics of the tone reproduction curves type.

TABLE 41

| Names | Description |
|---|---|
| NumOfRecords | This field, which is only present in the |
| | binary representation, specifies the number of |
| | record (DAC and RGB value) instances |
| | accommodated in the ToneReproductionCurves. |
| DAC_Value | An element describing discrete DAC values of input |
| | device. |
| RGB_Value | An element describing normalized gamma curve |
| | values with respect to DAC values. The order |
| | of describing the RGB_Value is Rn, Gn, Bn. |

Further, in the color correction parameter type represented in Table 40, the semantics of the conversion LUT are represented as the following Table 42. Herein, Table 42 is a table representing the semantics of the conversion LUT type.

TABLE 42

| Names | Description |
|---|---|
| RGB2XYZ_LUT | This look-up table (matrix) converts an image |
| | from RGB to CIE XYZ. The size of the [symbol] |
| | is 3 × 3 such as |
| | $[ \begin{matrix}{R}_{x} & {G}_{x} & {B}_{x} \\ {R}_{y} & {G}_{y} & {B}_{y} \\ {R}_{z} & {G}_{z} & {B}_{z}\end{matrix} ] [ \begin{matrix}{R}_{x} & {G}_{x} & {B}_{x} \\ {R}_{y} & {G}_{y} & {B}_{y} \\ {R}_{z} & {G}_{z} & {B}_{z}\end{matrix} ] .$ |
| | The way of describing the values in the binary |
| | representation is in the order of [Rₓ Rₓ, Gₓ Gₓ, Bₓ Bₓ; |
| | R_{y} R_{y}, G_{y} G_{y}, B_{y} B_{y}; |
| | R_{z} R_{z}, G_{z} G_{z}, B_{z} B_{z}]. |
| RGBScalar_Max | An element describing maximum RGB scalar |
| | values for GOG transformation. The order of |
| | describing the RGBScalar_Max is Rmax, Gmax, |
| | Bmax. |
| Offset_Value | An element describing offset values of input |
| | display device when the DAC is 0. The value |
| | is described in CIE XYZ form. The order of |
| | describing the Offset_Value is X, Y, Z. |
| Gain_Offset_Gamma | An element describing the gain, offset, gamma |
| | of RGB channels for GOG transformation. |
| | The size of the Gain_Offset_Gamma matrix is 3 × 3 [symbol] |
| | as |
| | $[ \begin{matrix}{Gain}_{r} & {Gain}_{g} & {Gain}_{b} \\ {Offset}_{r} & {Offset}_{g} & {Offset}_{b} \\ {Gamma}_{r} & {Gamma}_{g} & {Gamma}_{b}\end{matrix} ] [ \begin{matrix}{Gain}_{r} & {Gain}_{g} & {Gain}_{b} \\ {Offset}_{r} & {Offset}_{g} & {Offset}_{b} \\ {Gamma}_{r} & {Gamma}_{g} & {Gamma}_{b}\end{matrix} ] .$ |
| | The way of describing the values in the |
| | binary representation is in the order of |
| | [Gainr, Gaing, Gainb; Offsetr, Offsetg, |
| | Offsetb; Gammar, Gammag, Gammab]. |
| InverseLUT | This look-up table (matrix) converts an image |
| | form CIE XYZ to RGB. |
| | The [symbol] matrix is 3 × 3 such as |
| | $[ \begin{matrix}{R}_{x}^{\vert} & {G}_{x}^{\vert} & {B}_{x}^{\vert} \\ {R}_{y}^{\vert} & {G}_{y}^{\vert} & {B}_{y}^{\vert} \\ {R}_{z}^{\vert} & {G}_{z}^{\vert} & {B}_{z}^{\vert}\end{matrix} ] [ \begin{matrix}{R}_{x}^{\vert} & {G}_{x}^{\vert} & {B}_{x}^{\vert} \\ {R}_{y}^{\vert} & {G}_{y}^{\vert} & {B}_{y}^{\vert} \\ {R}_{z}^{\vert} & {G}_{z}^{\vert} & {B}_{z}^{\vert}\end{matrix} ] .$ |
| | The way of describing the values in the binary |
| | representation is in the order of [Rₓ^{\|} Rₓ^{\|}, |
| | Gₓ^{\|} Gₓ^{\|}, Bₓ^{\|} Bₓ^{\|}; R_{y}^{\|} R_{y}^{\|}, G_{y}^{\|} G_{y}^{\|}, |
| | B_{y}^{\|} B_{y}^{\|}; R_{z}^{\|} R_{z}^{\|}, G_{z}^{\|} G_{z}^{\|}, B_{z}^{\|} B_{z}^{\|}]. |

[symbol]

indicates data missing or illegible when filed

In addition, the semantics of the color correction parameter type are represented as the following Table 43. Herein, Table 43 is a table representing the semantics of the illuminant type.

TABLE 43

| Names | Description |
|---|---|
| ElementType | In the binary description, the following |
| | mapping table is used. |
| XY_Value | An element describing the chromaticity of the |
| | light source. The ChromaticityType is |
| | specified in ISO/IEC 21000-7. |
| Y_Value | An element describing the luminance of the |
| | light source between 0 and 100. |
| Correlated_CT | Indicates the correlated color temperature of |
| | the overall illumination. The value |
| | expression is obtained through quantizing the |
| | range [1667, 25000] into 28 bins in a non- |
| | uniform way as specified in ISO/IEC 15938-5. |

In the semantics of the illuminant type represented in Table 43, the illuminant of the element type may be represented by the binary representation as represented in the following Table 44. That is, in the semantics of the illuminant type represented in Table 43, the element type is encoded by the binary representation. Herein, Table 44 is a table representing the binary representation of the element type.

TABLE 44

| Illuminant | IlluminantType |
|---|---|
| 00 | xy and Y value |
| 01 | Correlated_CT |

Further, in the semantics of the color correction parameter type represented in Table 40, the semantics of an input device color gamut are represented as the following Table 45. Herein, Table 45 is a table representing the semantics of the input device color gamut type.

TABLE 45

| Names | Description |
|---|---|
| typeLength | This field, which is only present in the |
| | binary representation, specifies the length of |
| | each IDCG_Type instance in bytes. The value |
| | of this element is the size of the largest |
| | IDCG_Type instance, aligned to a byte boundary |
| | by bit stuffing using 0-7 '1' bits. |
| IDCG_Type | An element describing the type of input device |
| | color gamut (e.g., NTSC, SMPTE). |
| IDCG_Value | An element describing the chromaticity values |
| | of RGB channels when the DAC values are |
| | maximum.The [symbol] CG Value matrix is |
| | 3 × 2 such as |
| | $[ \begin{matrix}{x}_{r} & {y}_{r} \\ {x}_{g} & {y}_{g} \\ {x}_{b} & {y}_{b}\end{matrix} ] [ \begin{matrix}{x}_{r} & {y}_{r} \\ {x}_{g} & {y}_{g} \\ {x}_{b} & {y}_{b}\end{matrix} ] .$ |
| | The way of describing the values in the binary |
| | representation is in the order of [xᵣ xᵣ, yᵣ yᵣ, |
| | x_{g} x_{g}, y_{g} y_{g}, x_{b} x_{b}, y_{b} y_{b}]. |

[symbol]

indicates data missing or illegible when filed

Hereinafter, the binary representation, that is, the binary representation scheme of the sensory effect information through the sensory effect vocabulary, that is, an example the various sensory effects will be described in more detail. Herein, the various sensory effects of the multimedia contents may be a light effect, a colored light effect, a flash light effect, a temperature effect, a wind effect, a vibration effect, a water spray effect as a spraying effect, a scent effect, a fog effect, a color correction effect, a motion and feeling effect (for example, rigid body motion effect), a passive kinesthetic motion effect, a passive kinesthetic force effect, an active kinesthetic effect, a tactile effect, or the like.

First, describing in detail the light effect, the syntax of the light effect may be represented as the following Table 46. Herein, Table 46 is a table representing the syntax of the light effect.

```
TABLE 46
<!-- ################################################ -->
  <!-- SEV Light type -->
  <!-- ################################################ -->
  <complexType name=“LightType”>
    <complexContent>
      <extension base=“sedl:EffectBaseType”>
        <attribute name=“color”  type=“sev:colorType”
use=“optional”/>
        <attribute name=“intensity-value”
type=“sedl:intensityValueType”
          use=“optional”/>
        <attribute name=“intensity-range”
type=“sedl:intensityRangeType”
          use=“optional”/>
      </extension>
    </complexContent>
  </complexType>
  <simpleType name=“colorType”>
    <union memberTypes=“mpeg7:termReferenceType
sev:colorRGBType”/>
  </simpleType>
  <simpleType name=“colorRGBType”>
    <restriction base=“NMTOKEN”>
      <whiteSpace value=“collapse”/>
      <pattern value=“#[0-9A-Fa-f]{6}”/>
    </restriction>
  </simpleType>
```

Further, the binary encoding representation scheme or the binary representation of the light effect may be represented as the following Table 47. Herein, Table 47 is a table representing the binary representation of the light effect.

TABLE 47

| | Number of bits | Mnemonic |
|---|---|---|
| LightType{ | | |
| colorFlag | 1 | bslbf |
| intensityValueFlag | | bslbf |
| intensityRangeFlag | | bslbf |
| if(colorFlag) { | | |
| color | 9 | colorType |
| } | | |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |
| ColorType { | | |
| NamedcolorFlag | 1 | |
| If(NamedcolorFlag) { | | |
| NamedColorType | 9 | bslbf (Table 9) |
| } else { | | |
| colorRGBType | 56 | bslbf |
| } | | |
| } | | |

In addition, the semantics of the light effect may be represented as the following Table 48. Herein, Table 48 is a table representing the semantics of the light type.

TABLE 48

| Name | Definition |
|---|---|
| LightType | Tool for describing a light effect. |
| colorFlag | This field, which is only present in the |
| | representation, indicates the presence of the |
| | attribute. If it is 1 then the color attribu [symbol] |
| | present, otherwise the color attribute is not presen [symbol] |
| intensityValueFlag | This field, which is only present in the |
| | representation, indicates the presence of the inte [symbol] |
| | value attribute. If it is 1 then the intensity |
| | attribute is present, otherwise the intensity |
| | attribute is not present. |
| intensityRangeFlag | This field, which is only present in the |
| | representation, indicates the presence of |
| | intensityRange attribute. If it is 1 then the inte [symbol] |
| | range attribute is present, otherwise the intensity |
| | attribute is not present. |
| color | Describe the color fo [symbol] the light effect, de [symbol] |
| | classification scheme(CS) or RGB value [symbol] , |
| | CS ref [symbol] A.2.2 of ISO/IEC 23005-6 |
| | (Describes the color of the light effect as a ref [symbol] |
| | to a classification scheme term or as RGB value. |
| | that may be used for this purpose is the ColorCS |
| | d [symbol] in Annex A.2.1). |
| intensity-value | Describes the intensity of the light effect in te [symbol] |
| | illumination in lux. |
| intensity-range | Describes the domain of the intensity value. |

[symbol]

indicates data missing or illegible when filed

Further, in the semantics of the light type illustrated in FIG. 48, a color may be represented by the binary representation as represented in the following Table 49. That is, in the semantics of the light type represented in Table 48, the color is encoded by the binary representation. Herein, Table 49 is a table representing the binary representation of color, that is, a named color type.

TABLE 49

| NamedcolorType | Term ID of color |
|---|---|
| 000000000 | alice_blue |
| 000000001 | alizarin |
| 000000010 | amaranth |
| 000000011 | amaranth_pink |
| 000000100 | amber |
| 000000101 | amethyst |
| 000000110 | apricot |
| 000000111 | aqua |
| 000001000 | aquamarine |
| 000001001 | army_green |
| 000001010 | asparagus |
| 000001011 | atomic_tangerine |
| 000001100 | auburn |
| 000001101 | azure_color_wheel |
| 000001110 | azure_web |
| 000001111 | baby_blue |
| 000010000 | beige |
| 000010001 | bistre |
| 000010010 | black |
| 000010011 | blue |
| 000010100 | blue_pigment |
| 000010101 | blue_ryb |
| 000010110 | blue_green |
| 000010111 | blue-green |
| 000011000 | blue-violet |
| 000011001 | bondi_blue |
| 000011010 | brass |
| 000011011 | bright_green |
| 000011100 | bright_pink |
| 000011101 | bright_turquoise |
| 000011110 | brilliant_rose |
| 000011111 | brink_pink |
| 000100000 | bronze |
| 000100001 | brown |
| 000100010 | buff |
| 000100011 | burgundy |
| 000100100 | burnt_orange |
| 000100101 | burnt_sienna |
| 000100110 | burnt_umber |
| 000100111 | camouflage_green |
| 000101000 | caput_mortuum |
| 000101001 | cardinal |
| 000101010 | carmine |
| 000101011 | carmine_pink |
| 000101100 | carnation_pink |
| 000101101 | Carolina_blue |
| 000101110 | carrot_orange |
| 000101111 | celadon |
| 000110000 | cerise |
| 000110001 | cerise_pink |
| 000110010 | cerulean |
| 000110011 | cerulean_blue |
| 000110100 | champagne |
| 000110101 | charcoal |
| 000110110 | chartreuse_traditional |
| 000110111 | chartreuse_web |
| 000111000 | cherry_blossom_pink |
| 000111001 | chestnut |
| 000111010 | chocolate |
| 000111011 | cinnabar |
| 000111100 | cinnamon |
| 000111101 | cobalt |
| 000111110 | Columbia_blue |
| 000111111 | copper |
| 001000000 | copper_rose |
| 001000001 | coral |
| 001000010 | coral_pink |
| 001000011 | coral_red |
| 001000100 | corn |
| 001000101 | cornflower_blue |
| 001000110 | cosmic_latte |
| 001000111 | cream |
| 001001000 | crimson |
| 001001001 | cyan |
| 001001010 | cyan_process |
| 001001011 | dark_blue |
| 001001100 | dark_brown |
| 001001101 | dark_cerulean |
| 001001110 | dark_chestnut |
| 001001111 | dark_coral |
| 001010000 | dark_goldenrod |
| 001010001 | dark_green |
| 001010010 | dark_khaki |
| 001010011 | dark_magenta |
| 001010100 | dark_pastel_green |
| 001010101 | dark_pink |
| 001010110 | dark_scarlet |
| 001010111 | dark_salmon |
| 001011000 | dark_slate_gray |
| 001011001 | dark_spring_green |
| 001011010 | dark_tan |
| 001011011 | dark_turquoise |
| 001011100 | dark_violet |
| 001011101 | deep_carmine_pink |
| 001011110 | deep_cerise |
| 001011111 | deep_chestnut |
| 001100000 | deep_fuchsia |
| 001100001 | deep_lilac |
| 001100010 | deep_magenta |
| 001100011 | deep_magenta |
| 001100100 | deep_peach |
| 001100101 | deep_pink |
| 001100110 | denim |
| 001100111 | dodger_blue |
| 001101000 | ecru |
| 001101001 | egyptian_blue |
| 001101010 | electric_blue |
| 001101011 | electric_green |
| 001101100 | elctric_indigo |
| 001101101 | electric_lime |
| 001101110 | electric_purple |
| 001101111 | emerald |
| 001110000 | eggplant |
| 001110001 | falu_red |
| 001110010 | fern_green |
| 001110011 | firebrick |
| 001110100 | flax |
| 001110101 | forest_green |
| 001110110 | french_rose |
| 001110111 | fuchsia |
| 001111000 | fuchsia_pink |
| 001111001 | gamboge |
| 001111010 | gold_metallic |
| 001111011 | gold_web_golden |
| 001111100 | golden_brown |
| 001111101 | golden_yellow |
| 001111110 | goldenrod |
| 001111111 | grey-asparagus |
| 010000000 | green_color_wheel_x11_green |
| 010000001 | green_html/css_green |
| 010000010 | green_pigment |
| 010000011 | green_ryb |
| 010000100 | green_yellow |
| 010000101 | grey |
| 010000110 | han_purple |
| 010000111 | harlequin |
| 010001000 | heliotrope |
| 010001001 | Hollywood_cerise |
| 010001010 | hot_magenta |
| 010001011 | hot_pink |
| 010001100 | indigo_dye |
| 010001101 | international_klein_blue |
| 010001110 | international_orange |
| 010001111 | Islamic_green |
| 010010000 | ivory |
| 010010001 | jade |
| 010010010 | kelly_green |
| 010010011 | khaki |
| 010010100 | khaki_x11_light_khaki |
| 010010101 | lavender_floral |
| 010010110 | lavender_web |
| 010010111 | lavender_blue |
| 010011000 | lavender_blush |
| 010011001 | lavender_grey |
| 010011010 | lavender_magenta |
| 010011011 | lavender_pink |
| 010011100 | lavender_purple |
| 010011101 | lavender_rose |
| 010011110 | lawn_green |
| 010011111 | lemon |
| 010100000 | lemon_chiffon |
| 010100001 | light_blue |
| 010100010 | light_pink |
| 010100011 | lilac |
| 010100100 | lime_color_wheel |
| 010100101 | lime_web_x11_green |
| 010100110 | lime_green |
| 010100111 | linen |
| 010101000 | magenta |
| 010101001 | magenta_dye |
| 010101010 | magenta_process |
| 010101011 | magic_mint |
| 010101100 | magnolia |
| 010101101 | malachite |
| 010101110 | maroon_html/css |
| 010101111 | marron_x11 |
| 010110000 | maya_blue |
| 010110001 | mauve |
| 010110010 | mauve_taupe |
| 010110011 | medium_blue |
| 010110100 | medium_carmine |
| 010110101 | medium_lavender_magenta |
| 010110110 | medum_purple |
| 010110111 | medium_spring_green |
| 010111000 | midnight_blue |
| 010111001 | midnight_green_eagle_green |
| 010111010 | mint_green |
| 010111011 | misty_rose |
| 010111100 | moss_green |
| 010111101 | mountbatten_pink |
| 010111110 | mustard |
| 010111111 | myrtle |
| 011000000 | navajo_white |
| 011000001 | navy_blue |
| 011000010 | ochre |
| 011000011 | office_green |
| 011000100 | old_gold |
| 011000101 | old_lace |
| 011000110 | old_lavender |
| 011000111 | old_rose |
| 011001000 | olive |
| 011001001 | olive_drab |
| 011001010 | olivine |
| 011001011 | orange_color_wheel |
| 011001100 | orange_ryb |
| 011001101 | orange_web |
| 011001110 | orange_peel |
| 011001111 | orange-red |
| 011010000 | orchid |
| 011010001 | pale_blue |
| 011010010 | pale_brown |
| 011010011 | pale_carmine |
| 011010100 | pale_chestnut |
| 011010101 | pale_cornflower_blue |
| 011010110 | pale_magenta |
| 011010111 | pale_pink |
| 011011000 | pale_red-violet |
| 011011001 | papaya_whip |
| 011011010 | pastel_green |
| 011011011 | pastel_pink |
| 011011100 | peach |
| 011011101 | peach-orange |
| 011011110 | peach-yellow |
| 011011111 | pear |
| 011100000 | periwinkle |
| 011100001 | persian_blue |
| 011100010 | persian_green |
| 011100011 | persian_indigo |
| 011100100 | persian_orange |
| 011100101 | persian_red |
| 011100110 | persian_pink |
| 011100111 | persian_rose |
| 011101000 | persimmon |
| 011101001 | pine_green |
| 011101010 | pink |
| 011101011 | pink-orange |
| 011101100 | platinum |
| 011101101 | plum_web |
| 011101110 | powder_blue_web |
| 011101111 | puce |
| 011110000 | prussian_blue |
| 011110001 | psychedelic_purple |
| 011110010 | pumpkin |
| 011110011 | purple_html/css |
| 011110100 | purple_x11 |
| 011110101 | purple_taupe |
| 011110110 | raw_umber |
| 011110111 | razzmatazz |
| 011111000 | red |
| 011111001 | red_pigment |
| 011111010 | red_ryb |
| 011111011 | red-violet |
| 011111100 | rich_carmine |
| 011111101 | robin_egg_blue |
| 011111110 | rose |
| 011111111 | rose_madder |
| 100000000 | rose_taupe |
| 100000001 | royal_blue |
| 100000010 | royal_purple |
| 100000011 | ruby |
| 100000100 | russet |
| 100000101 | rust |
| 100000110 | safety_orange_blaze_orange |
| 100000111 | saffron |
| 100001000 | salmon |
| 100001001 | sandy_brown |
| 100001010 | sangria |
| 100001011 | sapphire |
| 100001100 | scarlet |
| 100001101 | school_bus_yellow |
| 100001110 | sea_green |
| 100001111 | seashell |
| 100010000 | selective_yellow |
| 100010001 | sepia |
| 100010010 | shamrock_green |
| 100010011 | shocking_pink |
| 100010100 | silver |
| 100010101 | sky_blue |
| 100010110 | slate_grey |
| 100010111 | smalt_dark_powder_blue |
| 100011000 | spring_bud |
| 100011001 | spring_green |
| 100011010 | steel_blue |
| 100011011 | tan |
| 100011100 | tangerine |
| 100011101 | tangerine_yellow |
| 100011110 | taupe |
| 100011111 | tea_green |
| 100100000 | tea_rose_orange |
| 100100001 | tea_rose_rose |
| 100100010 | teal |
| 100100011 | tenne_tawny |
| 100100100 | terra_cotta |
| 100100101 | thistle |
| 100100110 | tomato |
| 100100111 | turquoise |
| 100101000 | tyrian_purple |
| 100101001 | ultramarine |
| 100101010 | ultra_pink |
| 100101011 | united_nation_blue |
| 100101100 | vegas_gold |
| 100101101 | vermilion |
| 100101110 | violet |
| 100101111 | violet_web |
| 100110000 | violet_ryb |
| 100110001 | viridian |
| 100110010 | wheat |
| 100110011 | white |
| 100110100 | wisteria |
| 100110101 | yellow |
| 100110110 | yellow_process |
| 100110111 | yellow_ryb |
| 100111000 | yellow_green |
| 100111001-111111111 | Reserved |

In addition, the semantics of the light effect may be represented as the following Table 50. Herein, Table 50 is a table representing the semantics of the color RGB type.

TABLE 50

| Name | Definition |
|---|---|
| NamedcolorFlag | This field, which is only present in the |
| | binary representation, indicates a choice of |
| | the color descriptions. If it is 1 then the |
| | color is described by |
| | mpeg7:termReferenceType, otherwise the color |
| | is described by colorRGBType. |
| NamedColorType | This field, which is only present in the |
| | binary representation, describes color in |
| | terms of ColorCS Flag in Annex A.2.1. |
| colorRGBType | Tool for representing RGB colors (This |
| | field, which is only present in the binary |
| | representation, describes color in terms of |
| | colorRGBType). |

Next, describing in detail the flash effect, the syntax of the flash effect may be represented as the following Table 51. Herein, Table 51 is a table representing the syntax of the flash effect.

```
TABLE 51
<!-- ################################################ -->
  <!-- SEV Flash type -->
  <!-- ################################################ -->
  <complexType name=“FlashType”>
    <complexContent>
      <extension base=“sev:LightType”>
        <attribute name=“frequency”  type=“positiveInteger”
use=“optional”/>
      </extension>
    </complexContent>
  </complexType>
```

Further, the binary encoding representation scheme or the binary representation of the flash effect may be represented as the following Table 52. Herein, Table 52 is a table representing the binary representation of the flash effect.

TABLE 52

| FlashType { | Number of bits | Mnemonic |
|---|---|---|
| LightType | | LightType |
| frequencyFlag | 1 | bslbf |
| if(frequencyFlag) { | | |
| frequency | 5 | uimsbf |
| } | | |
| } | | |

In addition, the semantics of the flash effect may be represented as the following Table 53. Herein, Table 53 is a table representing the semantics of the flash type.

TABLE 53

| Name | Definition |
|---|---|
| FlashType | Tool for describing a flash effect. |
| LightType | Describes a base type of a light effect. |
| frequency | Describes the number of flickering in times |
| | per second. |
| | EXAMPLE - The value 10 means it will flicker |
| | 10 times for each second. |

Next, describing in detail the temperature effect, the syntax of the temperature effect may be represented as the following Table 54. Herein, Table 54 is a table representing the syntax of the temperature effect.

```
TABLE 54
<!-- ################################################ -->
  <!-- SEV Temperature type  -->
  <!-- ################################################ -->
  <complexType name=“TemperatureType”>
    <complexContent>
      <extension base=“sedl:EffectBaseType”>
        <attribute  name=“intensity-value”
type=“sedl:intensityValueType”
          use=“optional”/>
        <attribute  name=“intensity-range”
type=“sedl:intensityRangeType”
          use=“optional”/>
      </extension>
    </complexContent>
  </complexType>
```

Further, the binary encoding representation scheme or the binary representation of the temperature effect may be represented as the following Table 55. Herein, Table 55 is a table representing the binary representation of the temperature effect.

TABLE 55

| TemperatureType { | Number of bits | Mnemonic |
|---|---|---|
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |

In addition, the semantics of the temperature effect may be represented as the following Table 56. Herein, Table 56 is a table representing the semantics of the temperature type.

TABLE 56

| Name | Definition |
|---|---|
| TemperatureType | Tool for describing a temperature effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| intensity-value | Describes the intensity of the light effect |
| | in terms of heating/cooling in Celsius. |
| intensity-range | Describes the domain of the intensity value. |
| | intensity-range[0]: minmum intensity |
| | intensity-range[1]: maximum intensity |
| | EXAMPLE - [0.0, 100.0] on the Celsius scale |
| | or [32.0, 212.0] on the Fahrenheit scale. |

Next, describing in detail the wind effect, the syntax of the wind effect may be represented as the following Table 57. Herein, Table 57 is a table representing the syntax of the wind effect.

```
TABLE 57
<!-- ################################################ -->
  <!-- SEV Wind type  -->
  <!-- ################################################ -->
  <complexType name=“WindType”>
    <complexContent>
      <extension base=“sedl:EffectBaseType”>
        <attribute name=“intensity-value”
type=“sedl:intensityValueType”
          use=“optional”/>
        <attribute name=“intensity-range”
type=“sedl:intensityRangeType”
          use=“optional”/>
      </extension>
    </complexContent>
  </complexType>
```

Further, the binary encoding representation scheme or the binary representation of the wind effect may be represented as the following Table 58. Herein, Table 58 is a table representing the binary representation of the wind effect.

TABLE 58

| WindType{ | Number of bits | Mnemonic |
|---|---|---|
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |

In addition, the semantics of the wind effect may be represented as the following Table 59. Herein, Table 59 is a table representing the semantics of the wind type.

TABLE 59

| Name | Definition |
|---|---|
| WindType | Tool for describing a wind effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| intensity-value | Describes the intensity of the wind effect |
| | in terms of strength in Beaufort. |
| intensity-range | Describes the domain of the intensity value. |
| | intensity-range[0]: minmum intensity |
| | intensity-range[1]: maximum intensity |
| | EXAMPLE - [0.0, 12.0] on the Beaufort scale. |

Next, describing in detail the vibration effect, the syntax of the vibration effect may be represented as the following Table 60. Herein, Table 60 is a table representing the syntax of the vibration effect.

```
TABLE 60
<!-- ################################################ -->
  <!-- SEV Vibration type  -->
  <!-- ################################################ -->
  <complexType name=“VibrationType”>
    <complexContent>
      <extension base=“sedl:EffectBaseType”>
        <attribute  name=“intensity-value”
type=“sedl:intensityValueType”
          use=“optional”/>
        <attribute  name=“intensity-range”
type=“sedl:intensityRangeType”
          use=“optional”/>
      </extension>
    </complexContent>
  </complexType>
```

Further, the binary encoding representation scheme or the binary representation of the vibration effect may be represented as the following Table 61. Herein, Table 61 is a table representing the binary representation of the vibration effect.

TABLE 61

| VibrationType{ | Number of bits | Mnemonic |
|---|---|---|
| 0 intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |

In addition, the semantics of the vibration effect may be represented as the following Table 62. Herein, Table 62 is a table representing the semantics of the vibration type.

TABLE 63

| Name | Definition |
|---|---|
| VibrationType | Tool for describing a vibration effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| intensity-value | Describes the intensity of the vibration |
| | effect in terms of strength according to the |
| | Richter scale. |
| intensity-range | Describes the domain of the intensity value. |
| | intensity-range[0]: minmum intensity |
| | intensity-range[1]: maximum intensity |
| | EXAMPLE - [0.0, 10.0] on the Richter |
| | magnitude scale |

Next, describing in detail the spraying effect, the syntax of the spraying effect may be represented as the following Table 64. Herein, Table 64 is a table representing the syntax of the spraying effect.

```
TABLE 64
<!-- ################################################ -->
  <!-- Definition of Spraying type  -->
  <!-- ################################################ -->
  <complexType name=“SprayingType”>
    <complexContent>
      <extension base=“sedl:EffectBaseType”>
        <attribute  name=“intensity-value”
type=“sedl:intensityValueType”
          use=“optional”/>
        <attribute  name=“intensity-range”
type=“sedl:intensityRangeType”
          use=“optional”/>
        <attribute  name=“sprayingType”
type=“mpeg7:termReferenceType”/>
      </extension>
    </complexContent>
  </complexType>
```

Further, the binary encoding representation scheme or the binary representation of the spraying effect may be represented as the following Table 65. Herein, Table 65 is a table representing the binary representation of the spraying effect.

TABLE 65

| SprayingType { | Number of bits | Mnemonic |
|---|---|---|
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| SprayingID | 8 | bslbf (Table 10) |
| } | | |

In addition, the semantics of the spraying effect may be represented as the following Table 66. Herein, Table 66 is a table representing the semantics of the spraying type.

TABLE 66

| Name | Definition |
|---|---|
| SprayingType | Tool for describing a spraying effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| intensity-value | Describes the intensity of the spraying |
| | effect in terms in ml/h. |
| intensity-range | Describes the domain of the intensity |
| | value. |
| | intensity-range[0]: minmum intensity |
| | intensity-range[1]: maximum intensity |
| | EXAMPLE - [0.0, 10.0] ml/h. |
| sprayingType | Describes the type of the spraying effect |
| | as a reference to a classification scheme |
| | term. A CS that may be used for this |
| | purpose is the SprayingTypeCS defined in |
| | Annex A.2.6. |

In the semantics of the spraying effect represented in Table 66, the spraying type may be represented by the binary representation as represented in the following Table 67. That is, in the semantics of the spraying type represented in Table 66, the spraying type is encoded by the binary representation. Herein, Table 67 is a table representing the binary representation of the spraying type.

TABLE 67

| SprayingID | spraying type |
|---|---|
| 00000000 | Reserved |
| 00000001 | Purified Water |
| 00000010~11111111 | Reserved |

Next, describing in detail the scent effect, the syntax of the scent effect may be represented as the following Table 68. Herein, Table 68 is a table representing the syntax of the scent effect.

```
TABLE 68
<!-- ################################################ -->
  <!-- Definition of Scent type  -->
  <!-- ################################################ -->
  <complexType name=“ScentType”>
    <complexContent>
      <extension base=“sedl:EffectBaseType”>
        <attribute name=“scent” type=“mpeg7:termReferenceType”
          use=“optional”/>
        <attribute  name=“intensity-value”
type=“sedl:intensityValueType”
          use=“optional”/>
        <attribute  name=“intensity-range”
type=“sedl:intensityRangeType”
          use=“optional”/>
      </extension>
    </complexContent> </complexType>
```

Further, the binary encoding representation scheme or the binary representation of the scent effect may be represented as the following Table 69. Herein, Table 69 is a table representing the binary representation of the scent effect.

TABLE 69

| ScentType{ | Number of bits | Mnemonic |
|---|---|---|
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| ScentID | 16 | bslbf (Table 11) |
| } | | |

In addition, the semantics of the scent effect may be represented as the following Table 70. Herein, Table 70 is a table representing the semantics of the scent type.

TABLE 70

| Name | Definition |
|---|---|
| ScentType | Tool for describing a scent effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| scent | Describes the scent to use. A CS that may |
| | be used for this purpose is the ScentCS |
| | defined in Annex A.2.3. |
| intensity-value | Describes the intensity of the scent effect |
| | in ml/h |
| intensity-range | Describes the domain of the intensity |
| | value. |
| | intensity-range[0]: minmum intensity |
| | intensity-range[1]: maximum intensity |
| | EXAMPLE - [0.0, 10.0] ml/h. |

In the semantics of the scent effect represented in Table 70, the scent may be represented by the binary representation as represented in the following Table 71. That is, in the semantics of the scent type represented in Table 70, the color is encoded by the binary representation. Herein, Table 71 is a table representing the binary representation of the scent.

TABLE 71

| ScentID | Scent |
|---|---|
| 0000000000000000 | Reserved |
| 0000000000000001 | rose |
| 0000000000000010 | acacia |
| 0000000000000011 | chrysanthemum |
| 0000000000000100 | lilac |
| 0000000000000101 | mint |
| 0000000000000110 | jasmine |
| 0000000000000111 | pine tree |
| 0000000000001000 | orange |
| 0000000000001001 | grape |
| 0000000000001010~1111111111111111 | Reserved |

Next, describing in detail the fog effect, the syntax of the fog effect may be represented as the following Table 72. Herein, Table 72 is a table representing the syntax of the fog effect.

```
TABLE 72
<!-- ################################################ -->
  <!-- Definition of Fog type  -->
  <!-- ################################################ -->
  <complexType name=“FogType”>
    <complexContent>
      <extension base=“sedl:EffectBaseType”>
        <attribute  name=“intensity-value”
type=“sedl:intensityValueType”
          use=“optional”/>
        <attribute  name=“intensity-range”
type=“sedl:intensityRangeType”
          use=“optional”/>
      </extension>
    </complexContent>
  </complexType>
```

Further, the binary encoding representation scheme or the binary representation of the fog effect may be represented as the following Table 73. Herein, Table 73 is a table representing the binary representation of the fog effect.

TABLE 73

| FogType{ | Number of bits | Mnemonic |
|---|---|---|
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |

In addition, the semantics of the fog effect may be represented as the following Table 74. Herein, Table 74 is a table representing the semantics of the fog type.

TABLE 74

| Name | Definition |
|---|---|
| FogType | Tool for describing a fog effect. |
| intensityValueFlag | This field, which is only present in the |
| | binary representation, indicates the |
| | presence of the intensityValue attribute. |
| | If it is 1 then the intensity-value |
| | attribute is present, otherwise the |
| | intensity-value attribute is not present. |
| intensityRangeFlag | This field, which is only present in the |
| | binary representation, indicates the |
| | presence of the intensityRange attribute. |
| | If it is 1 then the intensity-range |
| | attribute is present, otherwise the |
| | intensity-range attribute is not present. |
| intensity-value | Describes the intensity of the fog effect |
| | in ml/h. |
| intensity-range | Describes the domain of the intensity |
| | value. |
| | intensity-range[0]: minmum intensity |
| | intensity-range[1]: maximum intensity |
| | EXAMPLE - [0.0, 10.0] ml/h. |

Next, describing in detail the color correction effect, the syntax of the color correction effect may be represented as the following Table 75. Herein, Table 75 is a table representing the syntax of the color correction effect.

```
TABLE 75
<!-- ################################################ -->
  <!-- Definition of Color Correction type  -->
  <!-- ################################################ -->
  <complexType name=“ColorCorrectionType”>
    <complexContent>
      <extension base=“sedl:EffectBaseType”>
        <choice minOccurs=“0”>
          <element  name=“SpatioTemporalLocator”
type=“mpeg7:SpatioTemporalLocatorType”/>
          <element  name=“SpatioTemporalMask”
type=“mpeg7:SpatioTemporalMaskType”/>
        </choice>
        <attribute  name=“intensity-value”
type=“sedl:intensityValueType”
          use=“optional”/>
        <attribute  name=“intensity-range”
type=“sedl:intensityRangeType”
          use=“optional” fixed=“0 1”/>
      </extension>
    </complexContent>
  </complexType>
```

Further, the binary encoding representation scheme or the binary representation of the color correction effect may be represented as the following Table 76. Herein, Table 76 is a table representing the binary representation of the color correction effect.

TABLE 76

| | (Num- | |
|---|---|---|
| | ber | |
| | of | |
| ColorCorrectionType{ | bits) | (Mnemonic) |
| intensityValueFlag | 1 | bslbf |
| intensityRangeFlag | 1 | bslbf |
| regionTypeChoice | 1 | bslbf |
| if(regionTypeChoice){ | | |
| SpatioTemporalLocator | | mpeg7:SpatioTemporalLocatorType |
| } | | |
| else{ | | |
| SpatioTemporalMask | | mpeg7:SpatioTemporalMaskType |
| } | | |
| if(intensityValueFlag) | | |
| { | | |
| Intensity-value | 32 | fsbf |
| } | | |
| if(intensityRangeFlag) | | |
| { | | |
| Intensity-range | 64 | fsbf |
| } | | |
| } | | |

In addition, the semantics of the color correction effect may be represented as the following Table 77. Herein, Table 77 is a table representing the semantics of the color correction type.

TABLE 77

| Names | Description |
|---|---|
| ColorCorrectionType | Tool for describing a ColorCorrection effect. |
| intensityValueFlag | This field, which is only present in the |
| | binary representation, indicates the presence |
| | of the intensityValue attribute. If it is 1 |
| | then the intensity-value attribute is |
| | present, otherwise the intensity-value |
| | attribute is not present. |
| intensityRangeFlag | This field, which is only present in the |
| | binary representation, indicates the presence |
| | of the intensityRange attribute. If it is 1 |
| | then the intensity-range attribute is |
| | present, otherwise the intensity-range |
| | attribute is not present. |
| regionTypeChoice | This field, which is only present in the |
| | binary representation, specifies the choice |
| | of the spatio-temporal region types. If it |
| | is 1 then the SpatioTemporalLocator is |
| | present, otherwise the SpatioTemporalMask is |
| | present. |
| intensity-value | Describes the intensity of the color |
| | correction effect in terms of “on” and “off” |
| | with respect to 1(on) and 0(off). |
| intensity-range | Describes the domain of the intensity value, |
| | i.e., 1 (on) and 0 (off). |
| | intensity-range[0]: minmum intensity |
| | intensity-range[1]: maximum intensity |
| SpatioTemporalLocator | Describes the spatio-temporal localization of |
| | the moving region using |
| | mpeg7:SpatioTemporalLocatorType (optional), |
| | which indicates the regions in a video |
| | segment where the color correction effect is |
| | applied. |
| | The mpeg7:SpatioTemporalLocatorType |
| | is Flag in ISO/IEC 15938-5. |
| SpatioTemporalMask | Describes a spatio-temporal mask that defines |
| | the spatio-temporal composition of the moving |
| | region (optional), which indicates the masks |
| | in a video segment where the color correction |
| | effect is applied. The |
| | mpeg7:SpatioTemporalMaskType is Flag in |
| | ISO/IEC 15938-5. |

Next, describing in detail the rigid body motion effect as the motion effect, the syntax of the ridge body motion effect may be represented as the following Table 78. Herein, Table 78 is a table representing the syntax of the ridge body motion effect.

```
TABLE 78
<!-- ################################################ -->
  <!-- Definition of Rigid Body Motion type  -->
  <!-- ################################################ -->
  <complexType name=“RigidBodyMotionType”>
    <complexContent>
      <extension base=“sedl:EffectBaseType”>
        <sequence>
          <element name=“MoveToward” type=“sev:MoveTowardType”
                  minOccurs=“0”/>
          <element  name=“TrajectorySamples”
type=“mpeg7:FloatMatrixType”
                  minOccurs=“0” maxOccurs=“unbounded”/>
```

| | | |
|---|---|---|
| <element | name=“Incline” | type=“sev:InclineType” |
| minOccurs=“0”/> | | |
| <element | name=“Shake” | type=“sev:ShakeType” |
| minOccurs=“0”/> | | |
| <element | name=“Wave” | type=“sev:WaveType” |
| minOccurs=“0”/> | | |
| <element | name=“Spin” | type=“sev:SpinType” |
| minOccurs=“0”/> | | |
| <element | name=“Turn” | type=“sev:TurnType” |
| minOccurs=“0”/> | | |
| <element | name=“Collide” | type=“sev:CollideType” |

```
minOccurs=“0”/>
        </sequence>
      </extension>
    </complexContent>
  </complexType>
  <!-- ################################################ -->
  <!-- Definition of Move Toward type  -->
  <!-- ################################################ -->
  <complexType name=“MoveTowardType”>
    <choice minOccurs=“0”>
      <element name=“Speed” type=“float”/>
      <element name=“Acceleration” type=“float”/>
    </choice>
    <attribute name=“directionV” type=“MoveTowardAngleType”
use=“optional” default=“0”/>
    <attribute name=“directionH” type=“MoveTowardAngleType”
use=“optional” default=“0”/>
    <attribute name=“distance” type=“float” use=“optional”/>
  </complexType>
  <!-- ################################################ -->
  <!-- Definition of Incline type  -->
  <!-- ################################################ -->
  <complexType name=“InclineType”>
    <sequence>
      <choice minOccurs=“0”>
        <element name=“PitchSpeed” type=“float”/>
        <element name=“PitchAcceleration” type=“float”/>
      </choice>
      <choice minOccurs=“0”>
        <element name=“rollSpeed” type=“float”/>
        <element name=“rollAcceleration” type=“float”/>
      </choice>
      <choice minOccurs=“0”>
        <element name=“yawSpeed” type=“float”/>
        <element name=“yawAcceleration” type=“float”/>
      </choice>
    </sequence>
    <attribute  name=“pitch” type=“sev:InclineAngleType”
use=“optional” default=“0”/>
    <attribute  name=“roll” type=“sev:InclineAngleType”
use=“optional” default=“0”/>
    <attribute  name=“yaw” type=“sev:InclineAngleType”
use=“optional” default=“0”/>
  </complexType>
  <!-- ################################################ -->
  <!-- Definition of Shake type  -->
  <!-- ################################################ -->
  <complexType name=“ShakeType”>
    <attribute name=“direction” type=“mpeg7:termReferenceType”
            use=“optional”/>
    <attribute name=“count” type=“float” use=“optional”/>
    <attribute name=“distance” type=“float” use=“optional”/>
  </complexType>
  <!-- ################################################ -->
  <!-- Definition of Wave type  -->
  <!-- ################################################ -->
  <complexType name=“WaveType”>
    <attribute name=“direction” type=“mpeg7:termReferenceType”
            use=“optional”/>
    <attribute  name=“startDirection”
type=“mpeg7:termReferenceType”
            use=“optional”/>
    <attribute name=“count” type=“float” use=“optional”/>
    <attribute name=“distance” type=“float” use=“optional”/>
  </complexType>
  <!-- ################################################ -->
  <!-- Definition of Spin type  -->
  <!-- ################################################ -->
  <complexType name=“SpinType”>
    <attribute name=“direction” type=“mpeg7:termReferenceType”
            use=“optional”/>
    <attribute name=“count” type=“float” use=“optional”/>
  </complexType>
  <!-- ################################################ -->
  <!-- Definition of Turn type  -->
  <!-- ################################################ -->
  <complexType name=“TurnType”>
    <attribute  name=“direction” type=“sev:TurnAngleType”
use=“optional”/>
    <attribute name=“speed” type=“float” use=“optional”/>
  </complexType>
  <!-- ################################################ -->
  <!-- Definition of Collide type  -->
  <!-- ################################################ -->
  <complexType name=“CollideType”>
    <attribute name=“directionH” type=“sev:MoveTowardAngleType”
            use=“optional” default=“0”/>
    <attribute name=“directionV” type=“sev:MoveTowardAngleType”
            use=“optional” default=“0”/>
    <attribute name=“speed” type=“float” use=“optional”/>
  </complexType>
  <!-- ################################################ -->
  <!-- Definition of Rigid Body Motion base type  -->
  <!-- ################################################ -->
  <simpleType name=“TurnAngleType”>
    <restriction base=“integer”>
      <minInclusive value=“−180”/>
      <maxInclusive value=“180”/>
    </restriction>
  </simpleType>
  <simpleType name=“InclineAngleType”>
    <restriction base=“integer”>
      <minInclusive value=“−359”/>
      <maxInclusive value=“359”/>
    </restriction>
  </simpleType>
  <simpleType name=“MoveTowardAngleType”>
    <restriction base=“integer”>
      <minInclusive value=“0”/>
      <maxInclusive value=“359”/>
    </restriction>
  </simpleType>
```

Further, the binary encoding representation scheme or the binary representation of the ridge body motion effect may be represented as the following Table 79. Herein, Table 79 is a table representing the binary representation of the ridge body motion effect.

TABLE 79

| | Number | |
|---|---|---|
| RigidBodyMotionEffect { | of bits | Mnemonic |
| MoveTowardFlag | 1 | bslbf |
| TrajectorySamplesFlag | 1 | bslbf |
| InclineFlag | 1 | bslbf |
| ShakeFlag | 1 | bslbf |
| WaveFlag | 1 | bslbf |
| SpinFlag | 1 | bslbf |
| TurnFlag | 1 | bslbf |
| CollideFlag | 1 | bslbf |
| If(MoveTowardFlag) { | | |
| MoveToward | | MoveTowardType |
| } | | |
| If(TrajectorySamplesFlag) { | | |
| SizeOfIntensityRow | 4 | uimsbf |
| SizeOfIntensityColumn | 16 | uimsbf |
| for(k=0;k<(SizeOfIntensityRow* | | |
| SizeOfIntensityColumn);k++) | | |
| { | | |
| ArrayIntensity[k] | 32 | fsfb |
| } | | |
| } | | |
| If(InclineFlag) { | | |
| Incline | | InclineType |
| } | | |
| If(ShakeFlag){ | | |
| Shake | | ShakeType |
| } | | |
| If(WaveFlag){ | | |
| Wave | | WaveType |
| } | | |
| If(SpinFlag){ | | |
| Spin | | SpinType |
| } | | |
| If(TurnFlag){ | | |
| Turn | | TurnType |
| } | | |
| If(CollideFlag){ | | |
| Collide | | CollideType |
| } | | |
| } | | |
| MoveTowardType{ | | |
| SpeedOrAccelerationFlag | 1 | bslbf |
| isSpeed | 1 | bslbf |
| distanceFlag | | |
| If(SpeedOrAccelerationFlag) | | |
| { | | |
| If(isSpeed) { | | |
| Speed | 32 | fsfb |
| } else { | | |
| Acceleration | 32 | fsfb |
| } | | |
| } | | |
| directionV | 9 | uimsbf |
| directionH | 9 | uimsbf |
| If(distanceFlag) { | | |
| distance | 32 | fsfb |
| } | | |
| } | | |
| InclineType { | | |
| PitchSpeedOrPitchAccelerationFlag | 1 | bslbf |
| isPitchSpeed | 1 | bslbf |
| RollSpeedOrRollAccelerationFlag | 1 | bslbf |
| isRollSpeed | 1 | bslbf |
| YawSpeedOrYawAccelerationFlag | 1 | bslbf |
| isYawSpeed | 1 | bslbf |
| If(PitchSpeedOrPitchAccelerationFlag) { | | |
| If(isPitchSpeed) { | | |
| PitchSpeed | 32 | fsfb |
| } else { | | |
| PitchAcceleration | 32 | fsfb |
| } | | |
| } | | |
| If(RollSpeedOrRollAccelerationFlag){ | | |
| If(isRollSpeed){ | | |
| RollSpeed | 32 | fsfb |
| } else { | | |
| RollAcceleration | 32 | fsfb |
| } | | |
| } | | |
| If(YawSpeedOrYawAccelerationFlag){ | | |
| If(isYawSpeed){ | | |
| YawSpeed | 32 | fsfb |
| } else { | | |
| YawAcceleration | 32 | fsfb |
| } | | |
| } | | |
| pitch | 10 | bslbf |
| roll | 10 | bslbf |
| yaw | 10 | bslbf |
| } | | |
| ShakeType{ | | |
| directionFlag | 1 | bslbf |
| countFlag | 1 | bslbf |
| distanceFlag | 1 | bslbf |
| If(directionFlag){ | | |
| direction | 2 | bslbf |
| } | | |
| If(countFlag){ | | |
| count | 32 | fsfb |
| } | | |
| If(distanceFlag){ | | |
| distance | 32 | fsfb |
| } | | |
| } | | |
| WaveType{ | | |
| directionFlag | 1 | bslbf |
| startDirectionFlag | 1 | bslbf |
| countFlag | 1 | bslbf |
| distanceFlag | 1 | bslbf |
| If(directionFlag){ | | |
| direction | 1 | bslbf |
| } | | |
| If(startDirectionFlag){ | | |
| startDirection | 1 | bslbf |
| } | | |
| If(countFlag){ | | |
| count | 32 | fsfb |
| } | | |
| If(distanceFlag){ | | |
| distance | 32 | fsfb |
| } | | |
| } | | |
| SpinType { | | |
| directionFlag | 1 | bslbf |
| countFlag | 1 | bslbf |
| If(directionFlag){ | | |
| direction | 3 | bslbf |
| } | | |
| If(countFlag){ | | |
| count | 32 | fsfb |
| } | | |
| } | | |
| TurnType { | | |
| directionFlag | 1 | bslbf |
| speedFlag | 1 | bslbf |
| If(directionFlag){ | | |
| direction | 9 | simsbf |
| } | | |
| If(speedFlag){ | | |
| speed | 32 | fsfb |
| } | | |
| } | | |
| CollideType{ | | |
| speedFlag | 1 | bslbf |
| directionH | 9 | uimsbf |
| directionV | 9 | uimsbf |
| If(speedFlag){ | | |
| speed | 32 | fsfb |
| } | | |
| } | | |

In addition, the semantics of the ridge body motion effect may be represented as the following Table 80. Herein, Table 80 is a table representing the semantics of the rigid body motion type.

TABLE 80

| Name | Definition |
|---|---|
| RigidBodyMotionType | Tool for describing a rigid body motion |
| | effect. |
| MoveTowardFlag | This field, which is only present in the |
| | binary representation, indicates the |
| | presence of the MoveToward element. If it |
| | is 1 then the MoveToward element is |
| | present, otherwise the MoveToward element |
| | is not present. |
| TrajectorySamplesFlag | This field, which is only present in the |
| | binary representation, indicates the |
| | presence of the TrajectorySamples element. |
| | If it is 1 then the TrajectorySamples are |
| | present, otherwise the TrajectorySamples |
| | are not present. |
| InclineFlag | This field, which is only present in the |
| | binary representation, indicates the |
| | presence of the Incline element. If it is |
| | 1 then the Incline element is present, |
| | otherwise the Incline element is not |
| | present. |
| ShakeFlag | This field, which is only present in the |
| | binary representation, indicates the |
| | presence of the Shake element. If it is 1 |
| | then the Shake element is present, |
| | otherwise the Shake element is not present. |
| WaveFlag | This field, which is only present in the |
| | binary representation, indicates the |
| | presence of the Wave element. If it is 1 |
| | then the Wave element is present, otherwise |
| | the Wave element is not present. |
| SpinFlag | This field, which is only present in the |
| | binary representation, indicates the |
| | presence of the Spin element. If it is 1 |
| | then the Spin element is present, otherwise |
| | the Spin element is not present. |
| TurnFlag | This field, which is only present in the |
| | binary representation, indicates the |
| | presence of the Turn element. If it is 1 |
| | then the Turn element is present, otherwise |
| | the Turn element is not present. |
| CollideFlag | This field, which is only present in the |
| | binary representation, indicates the |
| | presence of the Collide element. If it is |
| | 1 then the Collide element is present, |
| | otherwise the Collide element is not |
| | present. |
| MoveTorward | This pattern covers three dimensional |
| | movement of 6DoF, which means changing the |
| | location without rotation. The type is |
| | sev:MoveTorwardType. |
| TrajectorySamples | This pattern describes a set of position |
| | and orientation samples that the rigid body |
| | will follow. The type is |
| | mpeg7:termReferenceType. |
| SizeOfIntensityRow | Describes a row size of ArrayIntensity |
| | (Usually 6) |
| SizeOfIntensityColumn | Describes a column size of ArrayIntensity |
| ArrayInstensity | Describes 6 by ‘m’ matrix, where 6 rows |
| | contain three positions (Px, Py, Pz in |
| | millimeters) and three orientations (Ox, |
| | Oy, Oz in degrees). ‘m’ represents the |
| | number of position samples. |
| Incline | This pattern covers pitching, yawing, and |
| | rolling motion of 6 DoF, which means |
| | changing the rotation without changing the |
| | location. The type is sev:InclineType. |
| Shake | Represent pitching, yawing, rolling of 6Dof |
| | motion, represent rotation movement rather |
| | than position motion (This pattern is a |
| | continuous motion moving from one side to |
| | opposite side repeatedly. This is an |
| | abstracted motion pattern which can be |
| | alternatively expressed by repetition of |
| | Move pattern. The type is sev:ShakeType. |
| Wave | This pattern is a continuous motion from |
| | side-up to side-down like the surface of |
| | water. This is an abstracted motion |
| | pattern which can be alternatively |
| | expressed by repetition of rolling or |
| | pitching of Incline pattern. The type is |
| | sev:WaveType). |
| Spin | This pattern is a continuous turning based |
| | on a central point inside without change |
| | the place. This is an abstracted motion |
| | pattern which can be alternatively |
| | expressed by repetition of yawing of |
| | Incline pattern. The type is sev:SpinType. |
| Turn | This pattern is a motion of moving towards |
| | some direction. This is an abstracted |
| | motion pattern which can be alternatively |
| | expressed by repetition of Move and Incline |
| | pattern. The type is sev:TurnType. |
| Collide | This pattern is a motion of moving object |
| | collides against something. This is an |
| | abstracted motion pattern which can be |
| | alternatively expressed by repetition of |
| | Move and Incline pattern. The type is |
| | sev:CollideType. |

In the semantics of the ridge body motion type illustrated in FIG. 80, the move toward represents a movement 600 in a direction on the xyz coordinate as illustrated in FIG. 6. In this case, FIG. 6 is a diagram illustrating movement patterns in the sensory effects of the system for providing multimedia services in accordance with an exemplary embodiment of the present invention.

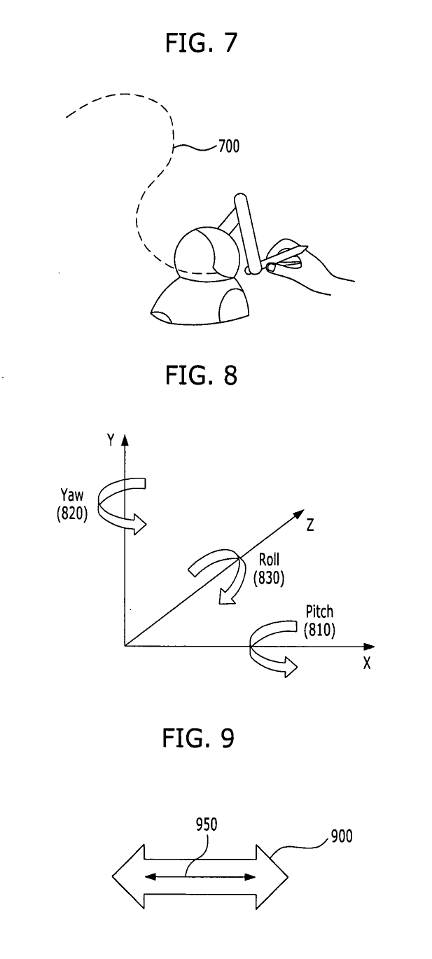

In addition, in the semantics of the ridge body motion type represented in Table 80, tranectory samples represents a set 700 of movement coordinates representing an orbit as illustrated in FIG. 7. FIG. 7 is a diagram illustrating motion orbit sample patterns in the sensory effects of the system for providing multimedia services in accordance with an exemplary embodiment of the present invention.

Further, in the semantics of the ridge body motion type represented in Table 80, the incline represents a pitch 810, a yaw 820, and a roll 830 on the xyz coordinate as illustrated in FIG. 8. In this case, FIG. 8 is a diagram illustrating incline patterns in the sensory effects of the system for providing multimedia services in accordance with an exemplary embodiment of the present invention.

Further, in the semantics of the ridge body motion type represented in Table 80, the shake represents a continuous movement pattern 950 performing reciprocal movement as illustrated in FIG. 9. In this case, FIG. 9 is a diagram illustrating shake patterns in the sensory effects of the system for providing multimedia services in accordance with an exemplary embodiment of the present invention.

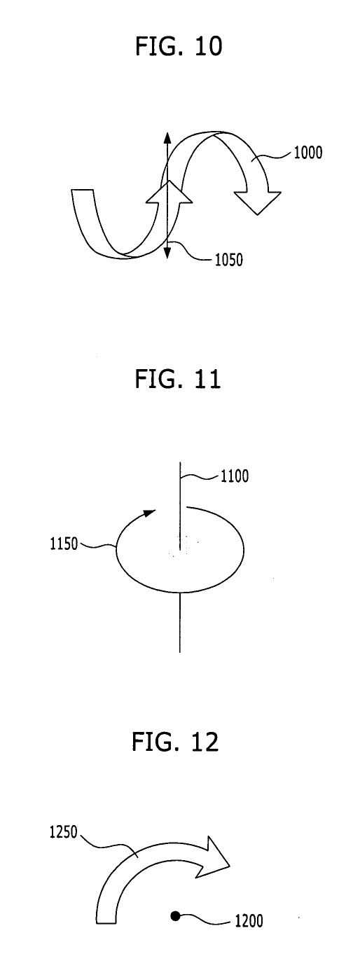

Further, in the semantics of the ridge body motion type represented in Table 80, the wave represents a continuous wave pattern 1050 like a side-up and a side-down 1000 of a water surface as illustrated in FIG. 10. In this case, FIG. 10 is a diagram illustrating wave patterns in the sensory effects of the system for providing multimedia services in accordance with an exemplary embodiment of the present invention.

Further, in the semantics of the ridge body motion type represented in Table 80, the spin represents a continuous movement pattern 1150 rotating based on one axis as illustrated in FIG. 11. In this case, FIG. 11 is a diagram illustrating spin patterns in the sensory effects of the system for providing multimedia services in accordance with an exemplary embodiment of the present invention.

Further, in the semantics of the ridge body motion type represented in Table 80, the turn represents a motion panel 1250 in a turn scheme rotating in the specific direction at a reference point 1200 during the progress as illustrated in FIG. 12. In this case, FIG. 12 is a diagram illustrating turn patterns in the sensory effects of the system for providing multimedia services in accordance with an exemplary embodiment of the present invention.

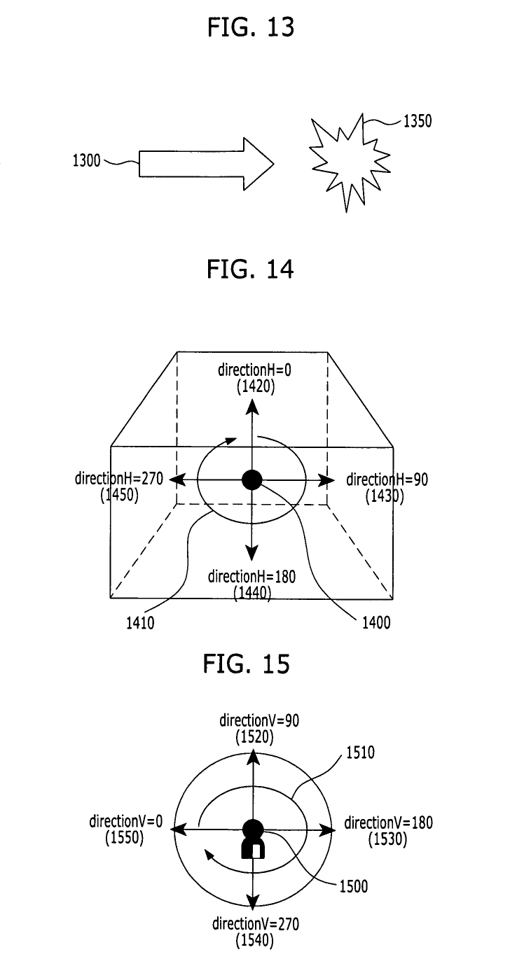

In addition, in the semantics of the ridge body motion type represented in Table 80, the collide represents an impact 1350 due to a collide of a predetermined object with other objects depending on a movement of other objects 1300 as illustrated in FIG. 13. In this case, FIG. 13 is a diagram illustrating a collide patterns in the sensory effects of the system for providing multimedia services in accordance with an exemplary embodiment of the present invention.

In addition, the semantics of the ridge body motion effect may be represented as the following Table 81. Herein, Table 81 is a table representing the semantics of the move toward type.

TABLE 81

| Name | Definition |
|---|---|
| SpeedOrAccelerationFlag | This field, which is only present in the |
| | binary representation, specifies the choice |
| | of the moveToward characterics. If it is 1 |
| | then the Speed or Acceleration element is |
| | present, otherwise the Speed or |
| | Acceleration element is not present |
| isSpeed | This field, which is only present in the |
| | binary representation, specifies the choice |
| | of the moveToward characterics. If it is 1 |
| | then the Speed element is present, |
| | otherwise the Acceleration element is |
| | present |
| distanceFlag | This field, which is only present in the |
| | binary representation, indicates the |
| | presence of the distance attribute. If it |
| | is 1 then the distance attribute is |
| | present, otherwise the distance attribute |
| | is not present. |
| Speed | Describes the moving speed in terms of |
| | centimeter per second. |
| Acceleration | Describes the acceleration in terms of |
| | centimeter per square second. |
| directionH | Describes the horizontal direction of |
| | moving in terms of angle. The type is |
| | sev:MoveTowardAngleType. The angle starts |
| | from the front-center of the rigid body and |
| | increases CCW. |
| directionV | Describes the vertical direction of moving |
| | in terms of angle. The type is |
| | sev:MoveTowardAngleType. The angle starts |
| | from the front-center of rigid body and |
| | increases CCW. |
| distance | Describes the distance between the origin |
| | and destination in terms of centimeter). |

In the semantics of the move toward type represented in Table 81, direction H represents a size of a horizontal direction movement through an angle unit as illustrated in FIG. 14. In this case, a horizontal direction movement 1410 at a predetermined position point 1400 is represented by direction H 0 (1430), direction H 90 (1430), direction H 180 (1430), and direction H 270 (1450).

FIG. 14 is a diagram illustrating horizontal direction movement patterns in the sensory effects of the system for providing multimedia services in accordance with the exemplary embodiment of the present invention.

In the semantics of the move toward type represented in Table 81, direction V represents a size of a horizontal direction movement through an angle unit as illustrated in FIG. 15. In this case, a horizontal direction movement 1510 at a predetermined position point 1500 is represented by direction V 0 (1520), direction V 90 (1530), direction V 180 (1540), and direction V 270 (1550).

FIG. 15 is a diagram illustrating horizontal direction movement patterns in the sensory effects of the system for providing multimedia services in accordance with the exemplary embodiment of the present invention.

In addition, the semantics of the ridge body motion effect may be represented as the following Table 82. Herein, Table 82 is a table representing the semantics of the incline type.

TABLE 82

| Name | Definition |
|---|---|
| PitchSpeedOrPitchAccelerationFlag | This field, which is only present in the |
| | binary representation, specifies the choice |
| | of the moveToward characterics. If it is 1 |
| | then the PitchSpeed or PitchAcceleration |
| | element is present, otherwise the |
| | PitchSpeed or PitchAcceleration element is not |
| | present |
| isPitchSpeed | This field, which is only present in the |
| | binary representation, specifies the choice |
| | of the pitch characterics. If it is 1 then |
| | the PitchSpeed element is present, |
| | otherwise the PitchAcceleration element is present |
| RollSpeedOrRollAccelerationFlag | This field, which is only present in the |
| | binary representation, specifies the choice |
| | of the moveToward characterics. If it is 1 |
| | then the RollSpeed or RollAcceleration |
| | element is present, otherwise the RollSpeed |
| | or RollAcceleration element is not present |
| isRollSpeed | This field, which is only present in the |
| | binary representation, specifies the choice |
| | of the roll characterics. If it is 1 then |
| | the RollSpeed element is present, otherwise |
| | the RollAcceleration element is present |
| YawSpeedOrYawAccelerationFlag | This field, which is only present in the |
| | binary representation, specifies the choice |
| | of the moveToward characterics. If it is 1 |
| | then the YawSpeed or YawAcceleration |
| | element is present, otherwise the YawSpeed |
| | or YawAcceleration element is not present |
| isYawSpeed | This field, which is only present in the |
| | binary representation, specifies the choice |
| | of the yaw characterics. If it is 1 then |
| | the YawSpeed element is present, otherwise |
| | the YawAcceleration element is present |
| PitchSpeed | Describes the rotation speed based on X- |
| | axis in terms of degree per second. |
| PitchAcceleration | Describes the acceleration based on X-axis |
| | in terms of degree per square second. |
| RollSpeed | Describes the rotation speed based on Z- |
| | axis in terms of degree per second. |
| RollAcceleration | Describes the acceleration based on Z-axis |
| | in terms of degree per square second. |
| YawSpeed | Describes the rotation speed based on Y- |
| | axis in terms of degree per second. |
| YawAcceleration | Describes the acceleration based on Y-axis |
| | in terms of degree per square second. |
| pitch | Describes the rotation based on X-axis in |
| | terms of angle. Positive value means the |
| | rotation angle in the direction of pitch |
| | arrow. |
| roll | Describes the rotation based on Z-axis in |
| | terms of angle. Positive value means the |
| | rotation angle in the direction of roll |
| | arrow. |
| yaw | Describes the rotation based on Y-axis in |
| | terms of angle. Positive value means the |
| | rotation angle in the direction of yaw |
| | arrow. |

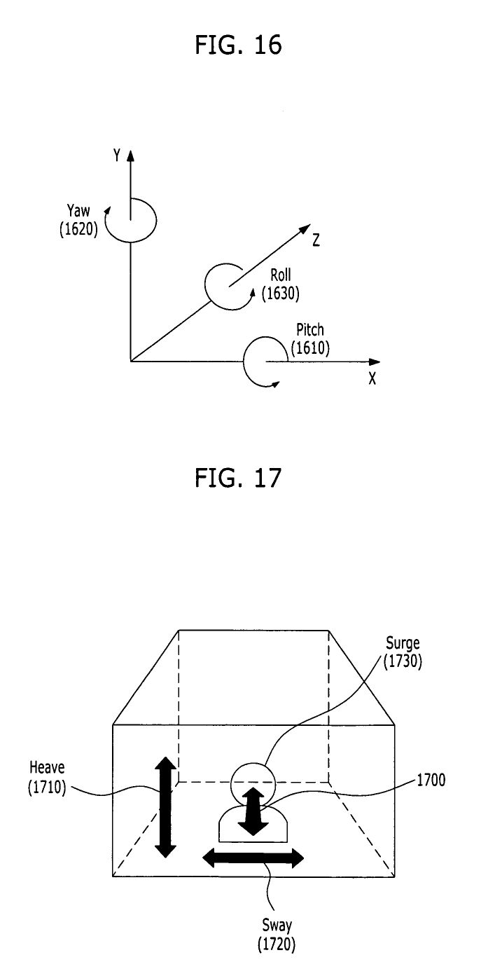

In the semantics of the incline type represented in Table 82, the pitch, the roll, and the yaw represent the size 1610 of rotation based on the x axis, the size 1620 of rotation based on the z axis, and the size 1630 of rotation based on the y axis, on each xyz coordinate axis In this case, FIG. 16 is a diagram illustrating directional incline patterns in the sensory effects of the system for providing multimedia services in accordance with an exemplary embodiment of the present invention.

In addition, the semantics of the ridge body motion effect may be represented as the following Table 83. Herein, Table 83 is a table representing the semantics of the shake type.

TABLE 83

| Name | Definition |
|---|---|
| directionFlag | This field, which is only present in the |
| | binary representation, indicates the |
| | presence of the direction attribute. If it |
| | is 1 then the direction attribute is |
| | present, otherwise the direction attribute |
| | is not present. |
| countFlag | This field, which is only present in the |
| | binary representation, indicates the |
| | presence of the count attribute. If it is |
| | 1 then the count attribute is present, |
| | otherwise the count attribute is not |
| | present. |
| distanceFlag | This field, which is only present in the |
| | binary representation, indicates the |
| | presence of the distance attribute. If it |
| | is 1 then the distance attribute is |
| | present, otherwise the distance attribute |
| | is not present. |
| direction | Describes the direction of the shake |
| | motion. A CS that may be used for this |
| | purpose is the ShakeDirectionCS defined in |
| | Annex A.2.4. |
| count | Describes the times to shake during the |
| | duration time. |
| distance | Describes the distance between the two ends |
| | of the shaking motion in terms of |
| | centimeter. |

In the semantics of shake type represented in Table 83, the direction represents a direction of a shake motion 1700 on a space as illustrated in FIG. 17, that is, represents a heave 1710, a sway 1720, and a surge 1730. In this case, FIG. 17 is a diagram illustrating directional incline patterns in the sensory effects of the system for providing multimedia services in accordance with an exemplary embodiment of the present invention. Further, the direction of the directional shake pattern may be represented by the binary representation as represented in the following Table 84. That is, in the semantics of the scent type represented in Table 83, the direction is encoded by the binary representation. Herein, Table 84 is a table representing the binary representation of direction.

TABLE 84

| direction (Shake) | Sementics |
|---|---|
| 00 | Reserved |
| 01 | Heave |
| 10 | Sway |
| 11 | Surge |

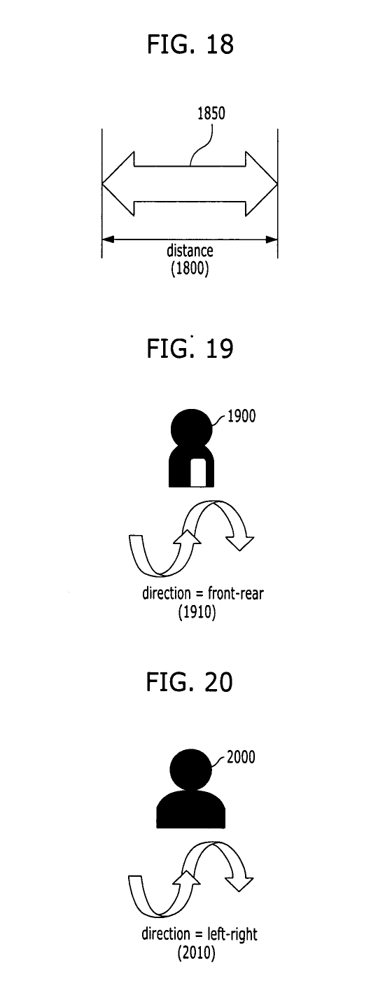

Further, the semantics of the shake type represented in Table 83, the distance represents a moving distance 1800 of the shake motion 1850 as illustrated in FIG. 18. FIG. 18 is a diagram illustrating a shake motion distance in the sensory effects of the system for providing multimedia services in accordance with an exemplary embodiment of the present invention.

In addition, the semantics of the ridge body motion effect may be represented as the following Table 85. Herein, Table 85 is a table representing the semantics of the wave type.

TABLE 85

| Name | Definition |
|---|---|
| directionFlag | This field, which is only present in the |
| | binary representation, indicates the |
| | presence of the direction attribute. If it |
| | is 1 then the direction attribute is |
| | present, otherwise the direction attribute |
| | is not present. |
| startDirectionFlag | This field, which is only present in the |
| | binary representation, indicates the |
| | presence of the startDirection attribute. |
| | If it is 1 then the startDirection |
| | attribute is present, otherwise the |
| | startDirection attribute is not present. |
| countFlag | This field, which is only present in the |
| | binary representation, indicates the |
| | presence of the count attribute. If it is |
| | 1 then the count attribute is present, |
| | otherwise the count attribute is not |
| | present. |
| distanceFlag | This field, which is only present in the |
| | binary representation, indicates the |
| | presence of the distance attribute. If it |
| | is 1 then the distance attribute is |
| | present, otherwise the distance attribute |
| | is not present. |
| direction | Describes the direction of the wave motion. |
| | A CS that may be used for this purpose is |
| | the WaveDirectionCS defined in Annex A.2.8. |
| startDirection | Describes whether it starts towards up |
| | direction or down direction. A CS that may |
| | be used for this purpose is the |
| | WaveStartDirectionCS defined in Annex |
| | A.2.9. |
| count | Describes the times to wave during the |
| | duration time. |
| distance | Describes the distance between the top and |
| | the bottom of the wave motion in |
| | centimeter. |

In the semantics of the wave type represented in Table 85, the direction represents the continuous wave pattern like a side-up and a side-down of a wave in predetermined positions 1900 and 2000 as illustrated in FIGS. 19 and 20, in particular, represents a front-rear 1910 and left-right 2010 of a wave pattern. FIGS. 19 and 20 are diagrams illustrating a wave motion direction in the sensory effects of the system for providing multimedia services in accordance with an exemplary embodiment of the present invention. Further, the direction of the wave pattern may be represented by the binary representation as represented in the following Table 86. That is, in the semantics of the wave type represented in Table 85, the direction is encoded by the binary representation. Herein, Table 86 is a table representing the binary representation of the direction.

TABLE 86

| direction (Wave) | Sementics |
|---|---|
| 0 | Left-Right |
| 1 | Front-Rear |

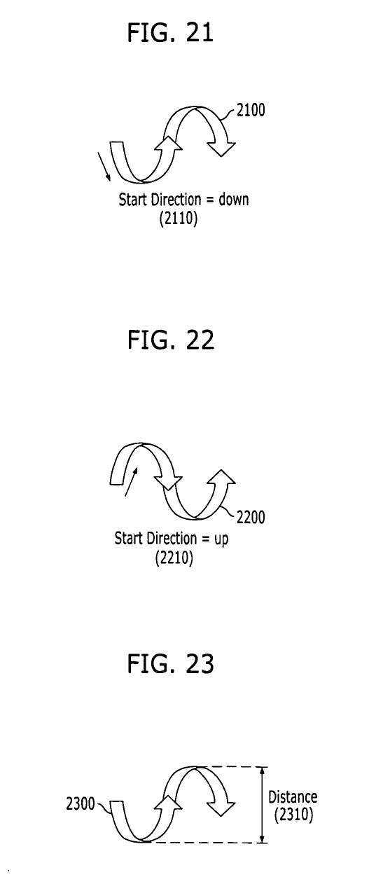

Further, the semantics of the wave type represented in Table 85, a start direction represents a start direction of the wave patterns 2100 and 2200 as illustrated in FIGS. 21 and 22, in particular, represents a down 2110 and an up 2210 of the start direction. FIGS. 21 and 22 are diagrams illustrating a wave motion start direction in the sensory effects of the system for providing multimedia services in accordance with an exemplary embodiment of the present invention. Further, the start direction of the wave pattern may be represented by the binary representation as represented in the following Table 87. That is, in the semantics of the wave type represented in Table 85, the start direction is encoded by the binary representation. Herein, Table 87 is a table representing the binary representation of the direction.

TABLE 87

| startDirection(Wave) | Sementics |
|---|---|
| 0 | Up |
| 1 | Down |

Further, the semantics of the wave type represented in Table 85, the distance represents a maximum distance 2310 of the wave pattern 2300 as illustrated in FIG. 23. FIG. 23 is a diagram illustrating a wave motion distance in the sensory effects of the system for providing multimedia services in accordance with an exemplary embodiment of the present invention.

In addition, the semantics of the ridge body motion effect may be represented as the following Table 88. Herein, Table 88 is a table representing the semantics of the turn type.

TABLE 88

| Name | Definition |
|---|---|
| directionFlag | This field, which is only present in the |
| | binary representation, indicates the |
| | presence of the direction attribute. If it |
| | is 1 then the direction attribute is |
| | present, otherwise the direction attribute |
| | is not present. |
| speedFlag | This field, which is only present in the |
| | binary representation, indicates the |
| | presence of the speed attribute. If it is |
| | 1 then the speed attribute is present, |
| | otherwise the speed attribute is not |
| | present. |
| direction | Describes the turning direction in terms of |
| | angle. The type is sev:TurnAngleType. |
| speed | Describes the turning speed in degree per |
| | second. |

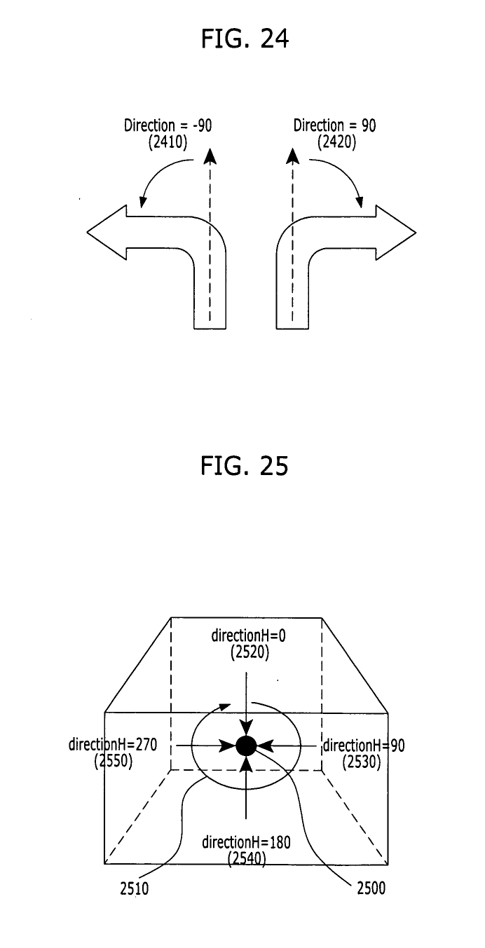

In the semantics of the turn type represented in Table 88, the direction represents the turn direction as illustrated in FIG. 24, in particular, the turn pattern direction −90 (2410) and direction 90 (2420). In this case, FIG. 24 is a diagram illustrating turn pattern direction in the sensory effects of the system for providing multimedia services in accordance with an exemplary embodiment of the present invention.

In addition, the semantics of the ridge body motion effect may be represented as the following Table 89. Herein, Table 89 is a table representing the semantics of the spin type.

TABLE 89

| Name | Definition |
|---|---|
| directionFlag | This field, which is only present in the |
| | binary representation, indicates the |
| | presence of the direction attribute. If it |
| | is 1 then the direction attribute is |
| | present, otherwise the direction attribute |
| | is not present. |
| countFlag | This field, which is only present in the |
| | binary representation, indicates the |
| | presence of the count attribute. If it is |
| | 1 then the count attribute is present, |
| | otherwise the count attribute is not |
| | present. |
| Direction | Describes the direction of the spinning |
| | based on the 3 axes. A CS that may be used |
| | for this purpose is the SpinDirectionCS |
| | defined in Annex A.2.5. |
| | NOTE 1Forward-spin based on x axis (which |
| | is “xf” in the classification scheme) |
| | indicates the spinning direction by the |
| | pitch arrow. Otherwise, backward-spin |
| | based on x axis (which is “xb” in the |
| | classification scheme) indicates the |
| | opposite spinning direction of “xf” |
| count | Describes the times to spin during the |
| | duration time. |

In the semantics of the spin type represented in Table 89, the direction may be represented by the binary representation as represented in the following Table 90. That is, in the semantics of the spin type represented in Table 89, the direction is encoded by the binary representation. Herein, Table 90 is a table representing the binary representation of the direction.

TABLE 90

| direction(Spin) | Sementics |
|---|---|
| 000 | Reserved |
| 001 | XF |
| 010 | XB |
| 011 | YF |
| 100 | YB |
| 101 | ZF |
| 110 | ZB |
| 111 | Reserved |

In addition, the semantics of the ridge body motion effect may be represented as the following Table 91. Herein, Table 91 is a table representing the semantics of the collide type.

TABLE 91

| Name | Definition |
|---|---|
| speedFlag | This field, which is only present in the |
| | binary representation, indicates the |
| | presence of the speed attribute. If it is |
| | 1 then the speed attribute is present, |
| | otherwise the speed attribute is not |
| | present. |
| directionH | Describes the horizontal direction of |
| | receiving impact in terms of angle. The |
| | type is sev:MoveTowardAngleType. The angle |
| | starts from the front-center of the rigid |
| | body and increases turning right. |
| directionV | Describes the vertical direction of |
| | receiving impact in terms of angle. The |
| | type is sev:TowardAngleType. The angle |
| | starts from the front-center of rigid body |
| | and increases turning up. |
| speed | Describes the speed of colliding object in |
| | terms of centimeter per second. |

In the collide type type semantics represented in Table 91, direction H represents a size of a horizontal direction movement through an angle unit as illustrated in FIG. 25. In this case, a horizontal direction movement 2510 at a predetermined position point 2500 is represented by direction H 0 (2520), direction H 90 (2530), direction H 180 (2540), and direction H 270 (2550). FIG. 25 is a diagram illustrating a horizontal direction collide patterns in the sensory effects of the system for providing multimedia services in accordance with the exemplary embodiment of the present invention.

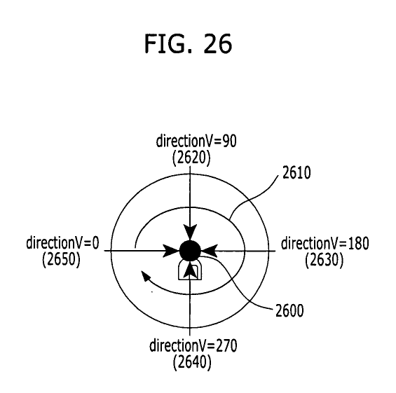

In the semantics of the collide type represented in Table 91, direction V represents a size of a vertical direction movement through an angle unit as illustrated in FIG. 26. In this case, a vertical direction movement 2610 at a predetermined position point 2600 is represented by direction V 0 (2620), direction V 90 (2630), direction V 180 (2640), and direction V 270 (2650). FIG. 26 is a diagram illustrating vertical direction collide patterns in the sensory effects of the system for providing multimedia services in accordance with the exemplary embodiment of the present invention.

Next, describing in detail the passive kinesthetic motion effect as the motion effect, the syntax of the passive kinesthetic motion effect may be represented as the following Table 92. Herein, Table 92 is a table representing the syntax of the passive kinesthetic motion effect.

```
TABLE 92
<!-- ################################################ -->
  <!-- SEV Passive Kinesthetic Motion type -->
  <!-- ################################################ -->
  <complexType name=“PassiveKinestheticMotionType”>
    <complexContent>
      <extension base=“sev:RigidBodyMotionType”>
        <attribute name=“updaterate” type=“positiveInteger”
use=“reguired”/>
      </extension>
    </complexContent>
  </complexType>
```

Further, the binary encoding representation scheme or the binary representation of the passive kinesthetic motion effect may be represented as the following Table 93. Herein, Table 93 is a table representing the binary representation of the passive kinesthetic motion effect.

TABLE 93

| PassiveKinestheticMotioin { | Number of bits | Mnemonic |
|---|---|---|
| RigidBodyMotionType | See subclauses | RigidBodyMotionType |
| updaterate | 16 | uimsbf |
| } | | |

In addition, the semantics of the passive kinesthetic motion effect may be represented as the following Table 94. Herein, Table 94 is a table representing the semantics of the passive kinesthetic motion type.

TABLE 94

| Name | Definition |
|---|---|
| PassiveKinestheticMotionType | Tool for describing a passive |
| | kinesthetic motion effect. This type |
| | defines a passive kinesthetic motion |
| | mode. In this mode, a user holds the |
| | kinesthetic device softly and the |
| | kinesthetic device guides the uwer's |
| | hand according to the recorded motion |
| | trajectories that are specified by |
| | three positions and three orientations. |
| TrajectorySamples | Tool for describing a passive |
| | kinesthetic interaction. The passive |
| | kinesthetic motion data is comprised |
| | with 6 by m matrix, where 6 rows |
| | contain three positions (Px, Py, Pz in |
| | millimeters) and three orientations (Ox, |
| | Oy, Oz in degrees). These six data |
| | are updated with the same updaterate). |
| updaterate | Describes a number of data update |
| | times per second. |
| | ex. The value 20 means the kinesthetic |
| | device will move to 20 different |
| | positions and orientations for each |
| | second. |

Next, describing in detail the passive kinesthetic force effect, the syntax of the passive kinesthetic force effect may be represented as the following Table 95. Herein, Table 95 is a table representing the syntax of the passive kinesthetic force effect.

```
TABLE 95
<!-- ################################################ -->
  <!-- SEV Passive Kinesthetic Force type -->
  <!-- ################################################ -->
  <complexType name=“PassiveKinestheticForceType”>
    <complexContent>
      <extension base=“sedl:EffectBaseType”>
        <sequence>
          <element name=“passivekinestheticforce”
                type=“mpeg7:FloatMatrixType”/>
        </sequence>
        <attribute name=“updaterate” type=“positiveInteger”
use=“required”/>
      </extension>
    </complexContent>
  </complexType>
```

Further, the binary encoding representation scheme or the binary representation of the passive kinesthetic force effect may be represented as the following Table 96. Herein, Table 96 is a table representing the binary representation of the passive kinesthetic force effect.

TABLE 96

| PassiveKinestheticForce { | Number of bits | Mnemonic |
|---|---|---|
| EffectBaseType | | EffectBaseType |
| SizeOfforceRow | 4 | uimsbf |
| SizeOfforceColumn | 16 | uimsbf |
| for(k=0;k<(SizeOfforceRow* | | |
| SizeOfforceColumn);k++) | | |
| { | | |
| force[k] | 32 | fsfb |
| } | | |
| updaterate | 16 | uimsbf |
| } | | |

In addition, the semantics of the passive kinesthetic force effect may be represented as the following Table 97. Herein, Table 97 is a table representing the semantics of the passive kinesthetic force type.

TABLE 97

| Name | Definition |
|---|---|
| PassiveKinestheticForceType | Tool for describing a passive kinesthetic |
| | force/torque effect. This type defines a |
| | passive kinesthetic force/torque mode. In |
| | this mode, a user holds the kinesthetic |
| | device softly and the kinesthetic device |
| | guides the user's hand according to the |
| | recorded force/toque histories. |
| passivekinestheticforce | Describes a passive kinesthetic |
| | force/torque sensation. The passive |
| | kinesthetic force/torque data are comprised |
| | with 6 by m matrix, where 6 rows contain |
| | three forces (Fx, Fy, Fz in Newton) and |
| | three torques (Tx, Ty, Tz in Newton- |
| | millimeter) for force/torque trajectories. |
| | These six data are updated with the same |
| | updaterate. |
| SizeOfforceRow | Describes a row size of force (Usually 6) |
| SizeOfforceColumn | Describes a column size of force |
| force | Describes 6 by ‘m’ matrix, where 6 rows |
| | contain three forces (Fx, Fy, Fz in |
| | Newton) and three torques (Tx, Ty, Tz in |
| | Newton- millimeter) for force/torque |
| | trajectories. ‘m’ represents the number |
| | of position samples. |
| updaterate | Describes a number of data update times |
| | per second. |

Next, describing in detail the active kinesthetic effect, the syntax of the active kinesthetic effect may be represented as the following Table 98. Herein, Table 98 is a table representing the syntax of the active kinesthetic effect.

```
TABLE 98
<!-- ################################################ -->
  <!-- SEV Active Kinesthetic type  -->
  <!-- ################################################ -->
  <complexType name=“ActiveKinestheticType”>
    <complexContent>
      <extension base=“sedl:EffectBaseType”>
        <sequence>
          <element name=“activekinesthetic”
                type=“sev:ActiveKinestheticForceType”/>
        </sequence>
      </extension>
    </complexContent>
  </complexType>
  <complexType name=“ActiveKinestheticForceType”>
    <attribute name=“Fx” type=“float”/>
    <attribute name=“Fy” type=“float”/>
    <attribute name=“Fz” type=“float”/>
    <attribute name=“Tx” type=“float” use=“optional”/>
    <attribute name=“Ty” type=“float” use=“optional”/>
    <attribute name=“Tz” type=“float” use=“optional”/>
  </complexType>
```

Further, the binary encoding representation scheme or the binary representation of the active kinesthetic effect may be represented as the following Table 99. Herein, Table 99 is a table representing the binary representation of the active kinesthetic effect.

TABLE 99

| ActiveKinesthetic { | Number of bits | Mnemonic |
|---|---|---|
| EffectBaseType | | EffectBaseType |
| TxFlag | 1 | bslbf |
| TyFlag | 1 | bslbf |
| TzFlag | 1 | bslbf |
| FxFlag | 1 | bslbf |
| FyFlag | 1 | bslbf |
| FzFlag | 1 | bslbf |
| if(TxFlag) { | | |
| Tx | 32 | fsfb |
| } | | |
| if(TyFlag) { | | |
| Ty | 32 | fsfb |
| } | | |
| if(TzFlag) { | | |
| Tz | 32 | fsfb |
| } | | |
| if(FxFlag) { | | |
| Fx | 32 | fsfb |
| } | | |
| If(FyFlag) { | | |
| Fy | 32 | fsfb |
| } | | |
| If(FzFlag) { | | |
| Fz | 32 | fsfb |
| } | | |
| } | | |

In addition, the semantics of the active kinesthetic effect may be represented as the following Table 100. Herein, Table 100 is a table representing the semantics of the active kinesthetic type.

TABLE 100

| Name | Definition |
|---|---|
| ActiveKinestheticType | Tool for describing an active kinesthetic |
| | effect. This type defines an active |
| | kinesthetic interaction mode. In this |
| | mode, when a user touches an object by |
| | his/her will, then the computed contact |
| | forces and torques are provided). |
| ActiveKinestheticForceType | Describes three forces (Fx, Fy, Fz) and |
| | torques (Tx, Ty, Tz) for each axis in an |
| | active kinesthetic mode. Force is |
| | represented in the unit of N(Newton) |
| | and torque is represented in the |
| | unit of Nmm(Newton-millimeter). |
| activekinesthetic | Describes a number of data |
| | update times per second (Tool for |
| | describing an active kinesthetic |
| | interaction). |
| txFlag | This field, which is only present in the |
| | binary representation, indicates the |
| | presence of the tx attribute. If it is 1 |
| | then the tx attribute is present, otherwise |
| | the tx attribute is not present. |
| tyFlag | This field, which is only present in the |
| | binary representation, indicates the |
| | presence of the ty attribute. If it is 1 |
| | then the ty attribute is present, otherwise |
| | the ty attribute is not present. |
| tzFlag | This field, which is only present in the |
| | binary representation, indicates the |
| | presence of the tz attribute. If it is 1 |
| | then the tz attribute is present, otherwise |
| | the tz attribute is not present. |
| fxFlag | This field, which is only present in the |
| | binary representation, indicates the |
| | presence of the fx attribute. If it is 1 |
| | then the fx attribute is present, otherwise |
| | the fx attribute is not present. |
| fyFlag | This field, which is only present in the |
| | binary representation, indicates the |
| | presence of the fy attribute. If it is 1 |
| | then the fy attribute is present, otherwise |
| | the fy attribute is not present. |
| fzFlag | This field, which is only present in the |
| | binary representation, indicates the |
| | presence of the fz attribute. If it is 1 |
| | then the fz attribute is present, otherwise |
| | the fz attribute is not present. |
| Tx | Torque for x-axis in an active kinesthetic |
| | mode. Torque is represented in the unit of |
| | Nmm(Newton-millimeter). |
| Ty | Torque for y-axis in an active kinesthetic |
| | mode. Torque is represented in the unit of |
| | Nmm(Newton-millimeter). |
| Tz | Torque for z-axis in an active kinesthetic |
| | mode. Torque is represented in the unit of |
| | Nmm(Newton-millimeter). |
| Fx | Force for x-axis in an active kinesthetic |
| | mode. Force is represented in the unit of |
| | N(Newton). |
| Fy | Force for y-axis in an active kinesthetic |
| | mode. Force is represented in the unit of |
| | N(Newton). |
| Fz | Force for z-axis in an active kinesthetic |
| | mode. Force is represented in the unit of |
| | N(Newton). |

Next, describing in detail the tactile effect, the syntax of the tactile effect may be represented as the following Table 101. Herein, Table 101 is a table representing the syntax of the tactile effect.

```
TABLE 101
<!-- ################################################ -->
  <!-- SEV Tactile type  -->
  <!-- ################################################ -->
  <complexType name=“TactileType”>
    <complexContent>
      <extension base=“sedl:EffectBaseType”>
        <sequence>
          <choice>
            <element  name=“ArrayIntensity”
type=“mpeg7:FloatMatrixType”/>
            <element name=“TactileVideo” type=“anyURI”/>
          </choice>
        </sequence>
        <attribute  name=“tactileEffect”
type=“mpeg7:termReferenceType” use=“optional”/>
<attribute name=“updaterate” type=“positiveInteger”
use=“optional”/>
      </extension>
    </complexContent>
</complexType>
```

Further, the binary encoding representation scheme or the binary representation of the tactile effect may be represented as the following Table 102. Herein, Table 102 is a table representing the binary representation of the tactile effect.

TABLE 102

| Tactile { | Number of bits | Mnemonic |
|---|---|---|
| EffectBaseType | | EffectBaseType |
| TactileFlag | 1 | bsblf |
| tactileEffectFlag | 1 | bsblf |
| updaterateflag | 1 | bsblf |
| if(TactileFlag) { | | |
| SizeOfIntensityRow | 4 | uimsbf |
| SizeOfIntensityColumn | 16 | uimsbf |
| for(k=0;k<(SizeOfIntensity | | |
| Row* | | |
| SizeOfIntensityColumn);k++ | | |
| ) { | | |
| ArrayInstensity[k] | 32 | fsfb |
| } | | |
| } | | |
| else { | | |
| TactileVideo | | UTF-8 |
| } | | |
| if(tactileEffectFlag){ | | |
| tactileEffect | 3 | bslbf (Table 16) |
| } | | |
| if(updaterateflag) { | | |
| updaterate | 16 | uimsbf |
| } | | |
| } | | |

In addition, the semantics of the tactile effect may be represented as the following Table 103. Herein, Table 103 is a table representing the semantics of the tactile type.

TABLE 103

| Name | Definition |
|---|---|
| TactileType | Tool for describing a tactile effect. |
| | Tactile effects can provide vibrations, |
| | pressures, temperature, etc, directly onto |
| | some areas of human skin through many types |
| | of actuators such as vibration motors, air- |
| | jets, piezo-actuators, thermal actuators. |
| | A tactile effect may effectively be |
| | represented by an ArrayIntensity or by a |
| | TactileVideo, all of which can be composed |
| | of m by n matrix that is mapped to m by n |
| | actuators in a tactile device. A Tactile |
| | Video is defined as a grayscale video |
| | formed with m-by-n pixels matched to the m- |
| | by-n tactile actuator array). |
| tactileFlag | Describe physical amount representing |
| | elements, that is, described intensity in a |
| | corresponding element unit (This field, |
| | which is only present in the binary |
| | representation, specifies the choice of the |
| | tectile effect source. If it is 1 then the |
| | ArrayIntensity is present, otherwise the |
| | TactileVideo is present). |
| tactileEffectFlag | This field, which is only present in the |
| | binary representation, indicates the |
| | presence of the tactileEffect attribute. |
| | If it is 1 then the tactileEffect attribute |
| | is present, otherwise the tactileEffect |
| | attribute is not present. |
| updateRateFlag | This field, which is only present in the |
| | binary representation, indicates the |
| | presence of the updateRate attribute. If |
| | it is 1 then the updateRate attribute is |
| | present, otherwise the updateRate attribute |
| | is not present. |
| SizeOfIntensityRow | Describes a row size of ArrayIntensity |
| | (Usually 6) |
| SizeOfIntensityColumn | Describes a column size of ArrayIntensity |
| ArrayIntensity | Describes intensities in terms of physical |
| | quantities for all elements of m by n |
| | matrix of the tactile actuators. For |
| | temperature tactile effect, for example, |
| | intensity is specified in the unit of |
| | Celsius. For vibration tactile effect, |
| | intensity is specified in the unit of mm |
| | (amplitude). For pressure tactile effect, |
| | intensity is specified in the unit of |
| | Newton/mm2 |
| TactileVideo | Describes intensities in terms of |
| | grayscale (0-255) video of tactile |
| | information. This grayscale value (0-255) |
| | can be divided into several levels |
| | according to the number of levels that a |
| | device produces. |
| tactileeffect | Describes the tactile effect to use. A CS |
| | that may be used for this purpose is the |
| | TactileEffectCS defined in Annex A.2.4. |
| | This refers the preferable tactile effects. |
| | In the binary description, the following |
| | mapping table is used. |
| updaterate | Describes a number of data update times per |
| | second. |

In the semantics of the tactile effect represented in Table 103, the tactile effect may be represented by the binary representation as represented in the following Table 104. That is, in the tactile type semantics represented in Table 103, the tactile effect is encoded by the binary representation. Herein, Table 104 is a table representing the binary representation of the tactile effect.

TABLE 104

| TactileEffect | TactileEffectType |
|---|---|
| 000 | vibration |
| 001 | temperature |
| 010 | pressure |
| 011~111 | Reserved |

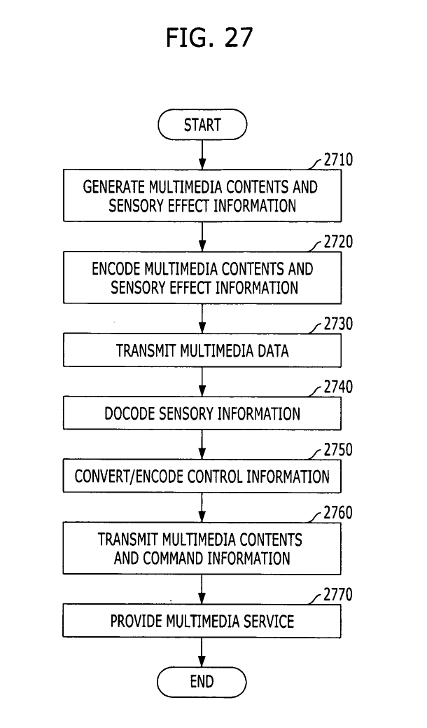

Hereinafter, an operation of the system for transmitting multimedia services in accordance with an exemplary embodiment of the present invention will be described in more detail with reference to FIG. 27.

FIG. 27 is a diagram schematically illustrating a process of providing multimedia services of the system for providing multimedia services in accordance with the exemplary embodiment of the present invention.

Referring to FIG. 27, at step 2710, the service provider of the system for providing multimedia services generates the multimedia contents of the multimedia services to be provided to the users and the sensory effect information of the multimedia contents depending on the service requests of the users.

Further, at step 2720, the service provider encodes the generated multimedia contents and encodes the sensory effect information by the binary representation, that is, the binary representation encoding scheme. In this case, the binary representation encoding of the sensory effect information will be described in detail and therefore, the detailed description thereof will be omitted herein.

Then, at step 2730, the service provider transmits the multimedia data including the encoded multimedia contents and the multimedia data including the sensory effect information encoded by the binary representation.

Next, at step 2740, the user server of the system for providing multimedia services receives the multimedia data and decodes the sensory effect information encoded by the binary representation in the received multimedia data.

In addition, at step 2750, the user server converts the sensory effect information into the command information in consideration of the capability information of each user device and encodes the converted command information using the binary representation, that is, the binary representation encoding scheme. In this case, the conversion of the command information and the binary representation encoding of the command information will be described in detail and therefore, the detailed description thereof will be omitted herein.

Then, at step S2760, the user server transmits the multimedia contents and the command information encoded by the binary representation to the user devices, respectively.

Further, at step 2770, each user device of the system for providing multimedia services simultaneously provides the multimedia contents and the sensory effects of the multimedia contents through the device command by the command information encoded by the binary representation to the users in real time, that is, the high quality of various multimedia services.

The exemplary embodiments of the present invention may stably provide the high quality of various multimedia services that each user wants to receive in a communication system, in particular, may provide the multimedia contents of the multimedia services and the various sensory effects of the multimedia contents to each user. In addition, the exemplary embodiments of the present invention transmit the multimedia contents and the various sensory effects of the multimedia contents at high speed by encoding the information representing the various sensory effects of the multimedia contents and thus, may provide the multimedia contents and the sensory effects to each user in real time, that is, may provide the high quality of various multimedia services to the users in real time.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

1. A system for providing multimedia services in a communication system, comprising:
a service provider configured to provide multimedia contents of the multimedia services and sensory effect information representing sensory effects of the multimedia contents, depending on service requests of multimedia services that users want to receive;
a user server configured to receive multimedia data including the multimedia contents and the sensory effect information and converts and provides the sensory effect information into command information in the multimedia data; and
user devices configured to provide the multimedia contents and the sensory effects to the users in real time through device command depending on command information.

2. The system of claim 1, wherein the service provider encodes the sensory effect information using binary representation.

3. The system of claim 2, wherein the multimedia data include the multimedia contents and the sensory effect information encoded by the binary representation

4. The system of claim 3, wherein the service provider includes:
a generator configured to generate the multimedia contents and the sensory effect information;
an encoder configured to encode the sensory effect information using a binary representation encoding scheme; and
a transmitter configured to transmit the multimedia data.

5. The system of claim 4, wherein the encoder encodes the sensory effect information into the sensory effect stream of the binary representation.

6. The system of claim 2, wherein the sensory effects includes a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, and a tactile effect.

7. The system of claim 6, wherein the service provider defines syntax, binary representation, and semantics of the sensory effects.

8. A system for providing multimedia services in a communication system, comprising:
a generator configured to generate multimedia contents of the multimedia services and generate sensory effect information representing sensory effects of the multimedia contents, depending on service requests of multimedia services that users want to receive;
an encoder configured to encode the sensory effect information using binary representation; and
a transmitter configured to transmit the multimedia contents and the sensory effect information encoded by the binary representation.

9. The system of claim 8, wherein the encoder encodes encodes the sensory effect information into the sensory effect stream of the binary representation

10. The system of claim 8, wherein the sensory effects includes a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, and a tactile effect.

11. The system of claim 10, wherein the encoder defines defines syntax, binary representation, and semantics of the sensory effects.

12. A method for providing multimedia services in a communication system, comprising:
generating multimedia contents of the multimedia services and generating sensory effect information representing sensory effects of the multimedia contents, depending on service requests of multimedia services that users want to receive;
encoding the sensory effect information into binary representation using a binary representation encoding scheme;
converting the sensory effect information encoded by the binary representation into command information of the binary representation; and
providing the multimedia contents and the sensory effects to the users in real time through device command depending on command information of the binary representation.

13. The method of claim 12, further comprising: transmitting the multimedia contents and multimedia data including the sensory effect information encoded by the binary representation.

14. The method of claim 12, wherein the encoding using the binary representation encodes the sensory effect information into the sensory effect stream of the binary representation

15. The method of claim 12, wherein the sensory effects includes a light effect, a colored light effect, a flash light effect, a temperature effect, a wind effect, a vibration effect, a spraying effect, a scent effect, a fog effect, a color correction effect, a rigid body motion effect, a passive kinesthetic motion effect, a passive kinesthetic force effect, an active kinesthetic effect, and a tactile effect.

16. The method of claim 15, wherein the encoding using the binary representation defines syntax, binary representation, and semantics of the sensory effects.
